(19) United States
(12) Patent Application Publication
(10) Pub. No.: US 2016/0214842 A1
(43) Pub. Date: Jul. 28, 2016

(54) UNIQUE ROADWORTHY SIDEWALK BOOM TRAILER, HAVING ON-SITE INTERCHANGEABLE BOOM, ON-SITE INTERCHANGEABLE LADDER, AND ON-SITE INTERCHANGEABLE CATWALK SIZED TO ACCESS NARROW OPENINGS AND NOOKS OVER AND UNDER BRIDGES

(71) Applicant: JEREMY HERAUF, FAIRVIEW, OR (US)

(72) Inventor: JEREMY HERAUF, FAIRVIEW, OR (US)

(21) Appl. No.: 14/604,001

(22) Filed: Jan. 23, 2015

(51) Int. Cl. B66F 11/04

(52) U.S. Cl. CPC B66F 11/044

(57) ABSTRACT

A unique roadworthy boom trailer comprises a roadworthy wheeled chassis, four independently-adjustable trailer-leveling motorized legs attached to the bottom of the chassis, pneumatic-tool compressor built in the chassis, turret assembly attached to the top of the chassis, and on-site-extendable-interchangeable quick-release assemblies of boom, ladder, and catwalk rotatably attached to the turret assembly. The ladder assembly has safety rungs for safety cables to be hooked thereon. The catwalk assembly has adjustable telescopic safety handrails. The unique roadworthy boom trailer can work with suspension-cable-or-truss-type bridges, low-or-high-power-line bridges, short-or-tall-supporting-column bridges, single-or-multiple-lane bridges, and regular-or-rail-road bridges. The catwalk assembly can have multiple additional catwalk assemblies attached thereto to extend its width or length to generally equal the width or length of a bridge, respectively. The catwalk assembly is sized to operate entirely within the width of a sidewalk, and to lift and shift equipment and personnel through narrow openings or into nooks both over and under bridges.

### FIELD OF THE INVENTION

The present invention relates to a unique built-in-pneumatic-tool-compressor interchangeable-extendable-boom-assembly roadworthy trailer. Particularly, the present invention relates to a unique built-in-pneumatic-tool-compressor on-site-extendable-interchangeable-boom on-site-extendable-interchangeable-ladder on-site-extendable-interchangeable-catwalk roadworthy-wheel-and-tire trailer, having:
1) Capabilities and dimensions to operate entirely within the width of a sidewalk;
2) Capabilities and dimensions to operate through small openings (each less than 30 inches wide);
3) Capabilities and dimensions to maneuver in small nooks and crannies under bridges;
4) Capabilities and dimensions to operate safely under low power lines;
5) Capabilities and dimensions to operate on:
   small and large suspension-cable-type bridges (suspension bridges),
   small and large truss-type bridges,
   small and large low-power-line bridges,
   small and large high-power-line bridges,
   small and large short-supporting-column bridges,
   small and large tall-supporting-column bridges,
   small and large single-lane bridges,
   small and large multiple-lane bridges,
   small and large regular bridges, and
   small and large rail-road bridges;
6) Capabilities and dimensions to be towed by a regular truck;
7) Roadworthy chassis, wheels, and tires;
8) Built-in pneumatic tool compressor;
9) Built-in independently-adjustable trailer-leveling motorized legs;
10) On-site-extendable-interchangeable boom;
11) On-site-extendable-interchangeable safety-cable-attaching-rung ladder; and
12) On-site-extendable-interchangeable adjustable-telescopic-safety-handrail catwalk.

### DESCRIPTION OF THE PRIOR ART

A number of boom vehicles have been introduced.

U.S. Pat. No. 3,262,517, patented 1966 Jul. 26, to J. P. Malec;
U.S. Pat. No. 3,357,517, patented 1967 Dec. 12, to E. A. Wagner;
U.S. Pat. No. 3,456,756, patented 1969 Jul. 22, to B. J. Price;
U.S. Pat. No. 3,608,669, patented 1971 Sep. 28, to Lindsay, Jr.;
U.S. Pat. No. 3,774,719, patented 1973 Nov. 27, to Lindsay, Jr.;
U.S. Pat. No. 4,044,858, patented 1977 Aug. 30, to Vikre;
U.S. Pat. No. 4,074,790, patented 1978 Feb. 21, to Colbachini, et al.;
U.S. Pat. No. 4,154,318, patented 1979 May 15, to Malleone;
U.S. Pat. No. 4,179,010, patented 1979 Dec. 18, to Ashworth;
U.S. Pat. No. 4,360,077, patented 1982 Nov. 23, to Abbott;
U.S. Pat. No. 4,449,611, patented 1984 May 22, to Frey-Wigger;
U.S. Pat. No. 4,461,369, patented 1984 Jul. 24, to Amador;
U.S. Pat. No. 4,556,124, patented 1985 Dec. 3, to Lotto;
U.S. Pat. No. 4,569,416, patented 1986 Feb. 11, to Stokoe;
U.S. Pat. No. 4,624,340, patented 1986 Nov. 25, to Astrom, et al.;
U.S. Pat. No. 4,633,975, patented 1987 Jan. 6, to Connor, et al.;
U.S. Pat. No. 4,646,875, patented 1987 Mar. 3, to Sholl;
U.S. Pat. No. 4,684,314, patented 1987 Aug. 4, to Luth;
U.S. Pat. No. 4,690,247, patented 1987 Sep. 1, to Yoshida;
U.S. Pat. No. 4,696,371, patented 1987 Sep. 29, to Moog;
U.S. Pat. No. 4,890,692, patented 1990 Jan. 2, to Oakman;
U.S. Pat. No. 5,011,710, patented 1991 Apr. 30, to Harrison;
U.S. Pat. No. 5,253,731, patented 1993 Oct. 19, to Moog;
U.S. Pat. No. 5,297,653, patented 1994 Mar. 29, to Wurtz, et al.;
U.S. Pat. No. 5,318,149, patented 1994 Jun. 7, to Moog;
U.S. Pat. No. 5,435,410, patented 1995 Jul. 25, to Langston;
U.S. Pat. No. 5,695,388, patented 1997 Dec. 9, to Lyras, et al.;
U.S. Pat. No. 5,746,286, patented 1998 May 5, to Mlaker;
U.S. Pat. No. 5,755,306, patented 1998 May 26, to Kraemer, et al.;
U.S. Pat. No. 6,250,485, patented 2001 Jun. 26, to Olson;
U.S. Pat. No. 6,507,163, patented 2003 Jan. 14, to Allen;
U.S. Pat. No. 6,585,079, patented 2003 Jul. 1, to Weyer;
U.S. Pat. No. 6,598,702, patented 2003 Jul. 29, to McGillewie, Jr., et al.;
U.S. Pat. No. 6,823,888, patented 2004 Nov. 30, to Raymond;
U.S. Pat. No. 7,035,758, patented 2006 Apr. 25, to Jerome;
U.S. Pat. No. 7,850,024, patented 2010 Dec. 14, to Schneider, et al.;
U.S. Pat. No. 7,926,670, patented 2011 Apr. 19, to Schneider;
U.S. Pat. No. 8,016,074, patented 2011 Sep. 13, to Black, et al.;
U.S. Pat. No. 8,083,461, patented 2011 Dec. 27, to Smith, et al.;
U.S. Pat. No. 8,467,741, patented 2013 Jun. 18, to Newman;
U.S. Pat. No. 8,857,567, patented 2014 Oct. 14, to Raymond;
U.S. Publication. No. 20020144862, published 2002 Oct. 10, to Engvall, David P.; and
U.S. Publication. No. 20040262078, published 2004 Dec. 30, to Bailey, Jeffrey H.
disclose a variety of inventions related to boom vehicles.

The prior art have failed to solve many problems associated with such boom vehicles, as follows:
1) No prior art (FIGS. 1 (PRIOR ART) and 2 (PRIOR ART) mention or disclose any boom trailer (having unique on-site-extendable-interchangeable quick-release boom assembly and on-site-extendable-interchangeable catwalk assembly), which.
   can lift and shift equipment and personnel through narrow openings over and under bridges (for example, through a less-than-30-inch-wide opening between two cables of a small suspension-cable-type bridge or between two posts of a small truss-type bridge),
   can lift and shift bridge-maintenance goods through narrow openings over and under bridges (for example, through a less-than-30-inch-wide opening between two cables of a small suspension-cable-type bridge or between two posts of a small truss-type bridge);

Therefore, the prior-art boom trailers are limited and expensive, and require additional boom trailers to maintain and service bridges.
2) No prior art (FIGS. 1 (PRIOR ART) and 2 (PRIOR ART) mention or disclose any boom trailer (having unique dimensions), which can maneuver and work in small areas, nooks, and crannies (for example, in a less-than-30-inch-wide nook or cranny) over and under all:
   small and large suspension-cable-type bridges (suspension bridges),
   small and large truss-type bridges,
   small and large low-power-line bridges,
   small and large high-power-line bridges,
   small and large short-supporting-column bridges,
   small and large tall-supporting-column bridges,
   small and large single-lane bridges,
   small and large multiple-lane bridges,
   small and large regular bridges, and
   small and large rail-road bridges.

Therefore, the prior-art boom trailers are limited in maneuvering through many narrow openings, and require a lot of labor, time, and money to maintain and service bridges.
3) No prior art (FIGS. 1 (PRIOR ART) and 2 (PRIOR ART) mention or disclose any boom trailer (having unique capabilities), which can work with all:
   small and large suspension-cable-type bridges (suspension bridges),
   small and large truss-type bridges,
   small and large low-power-line bridges,
   small and large high-power-line bridges,
   small and large short-supporting-column bridges,
   small and large tall-supporting-column bridges,
   small and large single-lane bridges,
   small and large multiple-lane bridges,
   small and large regular bridges, and
   small and large rail-road bridges.

Therefore, the prior-art boom trailers are limited and expensive, and require additional boom trailers to maintain and service bridges.
4) No prior art (FIGS. 1 (PRIOR ART) and 2 (PRIOR ART) mention or disclose any boom trailer (having unique dimensions, roadworthy chassis, roadworthy wheels, roadworthy tires, and four independently-adjustable trailer-leveling motorized legs), which can operate entirely within the width of a sidewalk, can be towed on the road at highway speed, and can be leveled when situated on uneven terrain.

Therefore, the prior-art boom trailers have to be disassembled, loaded on a roadworthy trailer, unloaded from a roadworthy trailer, and re-assembled when towed from one worksite to another. And therefore, the prior-art boom trailers are inconvenient, cumbersome, labor-intensive, time-consuming, and expensive to operate.
5) No prior art (FIG. 2 (PRIOR ART) mention or disclose any boom trailer (having unique dimensions, roadworthy chassis, roadworthy wheels, and roadworthy tires), which is compact, pre-installed, ready for operation, cheap to operate and maintain, and can be towed by a small, affordable, regular truck, which does not require any special driving license to be operated.

Therefore, the prior-art-boom trailers require big, expensive, and specialized trucks, and special driving license to operate it.
6) No prior art (FIGS. 1 (PRIOR ART) and 2 (PRIOR ART) mention or disclose any boom trailer (having unique built-in-pneumatic-tool compressor, pre-installed and ready-for-operation boom assembly, pre-installed and ready-for-operation ladder assembly, and pre-installed and ready-for-operation catwalk assembly), which reduces setup time, allows easy access to tight and usual spaces, is convenient, and saves time and money.

Therefore, the prior-art boom trailers require a lot of setup time, are inefficient in accessing and maneuvering in tight spaces over and under bridges, are inconvenient, and waste time and money.
7) No prior art (FIG. 1 (PRIOR ART) mention or disclose any boom trailer (having unique low compact profile sticking up in the air), which:
   Can work, safely, in the proximity of low power lines on bridges,
   Can deploy within a bridge sidewalk, and
   Can deploy within a bridge sidewalk and/or one traffic lane, with its compact boom & basket assembly never encroaching into the second traffic lane.

Therefore, the prior-art boom trailers cause a lot of injuries, property damage, medical expenses, and waste a lot of time and money.
8) No prior art (FIGS. 1 (PRIOR ART) and 2 (PRIOR ART) mention or disclose any boom trailer (having unique extendable and interchangeable quick-release boom assembly, extendable and interchangeable quick-release ladder assembly, extendable and interchangeable anti-slip-grid catwalk assembly, and vertically telescopic adjustable safety handrail on its catwalk), which can be reconfigured on site for a large variety of maintenance and service projects.

Therefore, the prior-art boom trailers require a lot of storage space, are cumbersome to transport, are cumbersome to maneuver together on a bridge, block traffic in multiple lanes, are expensive to operate, and are impossible to combine into one boom trailer.

### Objects and Advantages of the Invention

The present invention substantially departs from the conventional concepts and designs of the prior art. In doing so, the present invention provides a unique built-in-pneumatic-tool-compressor on-site-extendable-interchangeable-boom on-site-extendable-interchangeable-ladder on-site-extendable-interchangeable-catwalk roadworthy-wheel-and-tire trailer, having many unique and significant features, functions, and advantages, which overcome all the disadvantages of the prior art, as follows:
1) It is an object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Can work on:
      small and large suspension-cable-type bridges (suspension bridges),
      small and large truss-type bridges,
      small and large low-power-line bridges,
      small and large high-power-line bridges,
      small and large short-supporting-column bridges,
      small and large tall-supporting-column bridges,
      small and large single-lane bridges,
      small and large multiple-lane bridges,
      small and large regular bridges, and
      small and large rail-road bridges;
   b) Has an extendable interchangeable quick-release boom assembly and an extendable interchangeable anti-slip-grid catwalk assembly, which can maneuver and work in small areas, nooks, and crannies under:
      small and large suspension-cable-type bridges (suspension bridges),
      small and large truss-type bridges,
      small and large low-power-line bridges,
      small and large high-power-line bridges,
      small and large short-supporting-column bridges,
   small and large tall-supporting-column bridges,
   small and large single-lane bridges,
   small and large multiple-lane bridges,
   small and large regular bridges, and
   small and large rail-road bridges;
   c) Has an extendable interchangeable quick-release boom assembly and an extendable interchangeable anti-slip-grid catwalk assembly, which:
      can lift and shift equipment and personnel through narrow openings over and under bridges (for example, through a less-than-30-inch-wide opening between two cables of a small suspension-cable-type bridge or between two posts of a small truss-type bridge),
      can lift and shift bridge-maintenance goods through narrow openings over and under bridges (for example, through a less-than-30-inch-wide opening between two cables of a small suspension-cable-type bridge or between two posts of a small truss-type bridge);
   d) Has four independently-adjustable trailer-leveling motorized legs for adjusting the height at the trailer's four corners, to level the trailer when situated on uneven terrain;
   e) Has roadworthy chassis, wheels, and tires such that the unique trailer can be towed at highway speed; and
   f) Can be sized to operate entirely within the width of a sidewalk.
2) It is another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Is able to be towed from one bridge to another, with its boom assembly, ladder assembly, and catwalk assembly pre-installed thereon,
   b) Eliminates the need for an extra roadworthy trailer to carry it from one bridge to another,
   c) Saves materials, production costs, labor, time, and money,
   d) Eliminates the need for loading it on a roadworthy trailer to carry it to a worksite,
   e) Eliminates the need for unloading it from a roadworthy trailer,
   f) Eliminates the need for assembling it,
   g) Eliminates the need for disassembling it, and
   h) Eliminates the need for loading it back on a roadworthy trailer to carry it to another worksite.
3) It is a further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Is compact, versatile, pre-installed, and ready for operation,
   b) Is cheap to operate and maintain,
   c) Can be towed by a small, affordable, regular truck, which does not require any special driving license to be operated,
   d) Eliminates the need for big, expensive, and specialized truck, and special driving license, and
   e) Reduces setup time, and saves time and money.
4) It is an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which, having its turret assembly permanently welded to its deck, and its boom assembly and catwalk assembly pre-installed:
   a) Provides stability,
   b) Eliminates the need for setting it up, and
   c) Saves setup labor and time.
5) It is another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has a low compact profile sticking up in the air,
   b) Can provide a safe working trailer, in the proximity of low power lines on bridges,
   c) Can deploy within a bridge sidewalk, and
   d) Can deploy within a bridge sidewalk and/or one traffic lane, with its compact boom and catwalk assembly never encroaching into the second traffic lane.
6) It is yet another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has vertically telescopic adjustable safety handrail on its catwalk or basket for workers to lean on and hold on while working, for added safety,
   b) Has safety rungs for safety cables, yoyos, fall arrest systems, and/or lanyards to be attached thereto for added safety and maneuverability of workers, and
   c) Prevents accidents and personal injuries, and saves time and money.
7) It is still yet another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has extendable and interchangeable quick-release boom assembly (with quick-release pins for quick and easy reconfiguration while situated on a bridge) for specific bridge maintenances and services, to provide efficiency, to provide extended horizontal and vertical reaches, to save time, and to save bridge-maintenance-and-service costs,
   b) Has extendable and interchangeable quick-release ladder assembly (with quick-release pins for quick and easy reconfiguration while situated on a bridge) for specific bridge maintenances and services, to provide efficiency, to provide extended horizontal and vertical reaches, to save time, and to save bridge-maintenance-and-service costs, and
   c) Has extendable and interchangeable anti-slip-grid catwalk or basket assembly (with quick-release pins for quick and easy reconfiguration while situated on a bridge) for specific bridge maintenances and services, to provide efficiency, to provide extended horizontal and vertical reaches, to save time, and to save bridge-maintenance-and-service costs.
8) It is still yet an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has convenient built-in-pneumatic-tool compressor to run power tools,
   b) Has easily and safely accessible, walk-in utility vaults & utility storage, and
   c) Has hydraulic motor, pump, and tank located next to the turret assembly to allow for quick activation of the hydraulic system, and save materials, production costs, and money,
9) It is still yet an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has the turret control located to its catwalk or basket to be operated therefrom to prevent accidents and personal injuries, and to increase efficiency, and
   b) Has fuel filler located next to its sidewalk side to be easily accessible, to provide safety, convenience, and efficiency when refilling the unique trailer's fuel tank.
10) It is still yet an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has its deck fully coated with anti-slip coating to prevent personal injuries, and
   b) Has angled stop-and-go lights relocated to its two front corners to allow both driver and worker see them to better communicate with each other to increase efficiency and to prevent personal injuries.

Other objects and advantages of the present invention will become apparent from a consideration of the accompanying drawings and ensuing description.

### BRIEF DESCRIPTION OF THE DRAWINGS

FIG. 1 (Prior Art) illustrates the disadvantages of the prior art.

FIG. 2 (Prior Art) illustrates the additional disadvantages of the prior art.

FIGS. 3A, 3B, 3C, 3D, 3E, 3F, and 3G illustrate the unique roadworthy trailer, having anti-slip safety deck, independently-adjustable trailer-leveling motorized legs, built-in-pneumatic-tool compressor, on-site-extendable-interchangeable boom assembly, on-site-extendable-interchangeable ladder assembly, on-site-extendable-interchangeable catwalk assembly, and telescopic safety-handrail assembly.

FIG. 4 illustrates how the extendable interchangeable telescopic-safety-handrail catwalk system can lift and shift equipment and personnel through a narrow gap less than 30 inches wide between two cables of a suspensions-cable-type bridge.

FIG. 5 illustrates how the extendable interchangeable telescopic-safety-handrail catwalk system can lift and shift equipment and personnel through a narrow nook less than 30 inches wide between two posts of a truss-type bridge.

FIGS. 6A and 6B illustrate how the extendable interchangeable telescopic-safety-handrail catwalk system can lift and shift equipment and personnel through a narrow nook less than 30 inches wide between two posts of a column-type bridge.

FIGS. 7A and 7B illustrate how the telescopic safety-handrail assembly is vertically extended and secured.

FIG. 8 illustrates an equivalent variation of the extendable interchangeable anti-slip-grid catwalk system.

FIG. 9 illustrates how each of the independently-adjustable trailer-leveling motorized legs is independently adjusted to level the unique roadworthy trailer when situated on an uneven surface of a bridge.

FIGS. 10A, 10B, 10C, and 10D illustrate how to couple three extendable interchangeable anti-slip-grid catwalk systems, working together.

FIGS. 11 and 12 illustrate how two extendable interchangeable anti-slip-grid catwalk systems are coupled together under a bridge to provide a unique extended platform for personnel to maintain and service the entire width of a bridge.

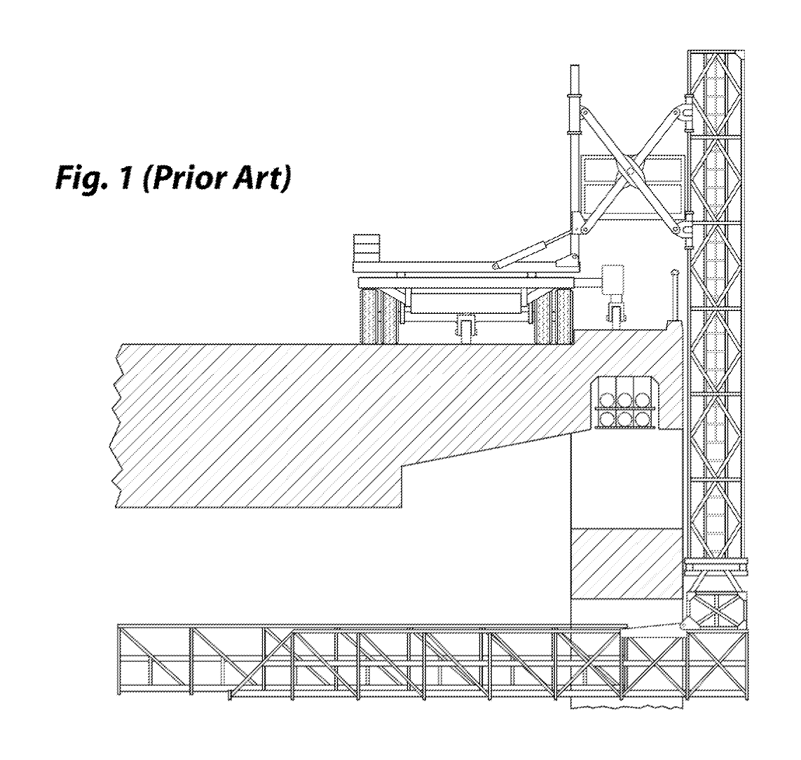

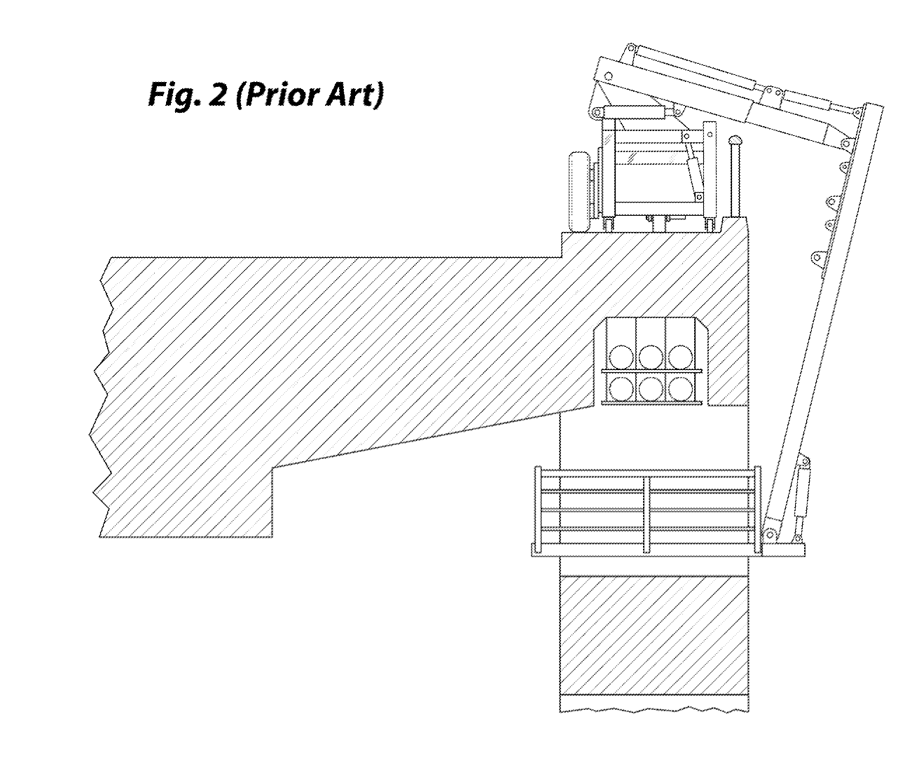

### SUMMARY OF THE INVENTION

A unique roadworthy boom trailer comprises a roadworthy wheeled chassis, four independently-adjustable trailer-leveling motorized legs attached to the bottom of the chassis, pneumatic-tool compressor built in the chassis, turret assembly attached to the top of the chassis, and on-site-extendable-interchangeable quick-release assemblies of boom, ladder, and catwalk rotatably attached to the turret assembly. The ladder assembly has safety rungs for safety cables to be hooked thereon. The catwalk assembly has adjustable telescopic safety handrails. The unique roadworthy boom trailer can work with suspension-cable-or-truss-type bridges, low-or-high-power-line bridges, short-or-tall-supporting-column bridges, single-or-multiple-lane bridges, and regular-or-rail-road bridges. The catwalk assembly can have multiple additional catwalk assemblies attached thereto to extend its width or length to generally equal the width or length of a bridge, respectively. The catwalk assembly is sized to operate entirely within the width of a sidewalk, and to lift and shift equipment and personnel through narrow openings or into nooks both over and under bridges.

### DETAILED DESCRIPTION OF THE INVENTION

### Component

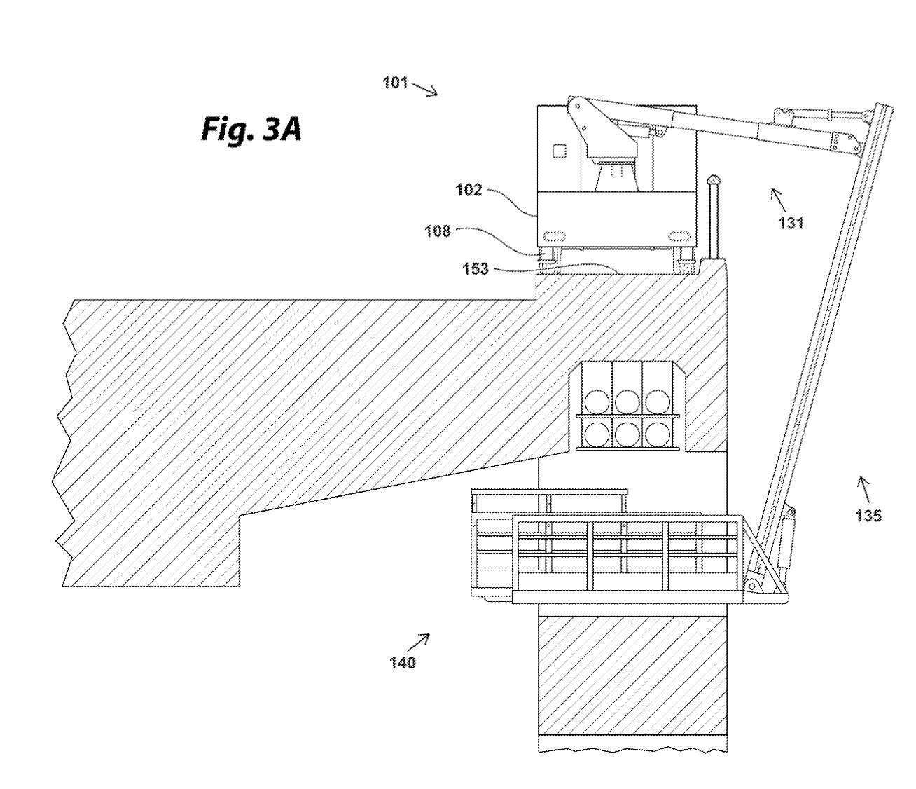

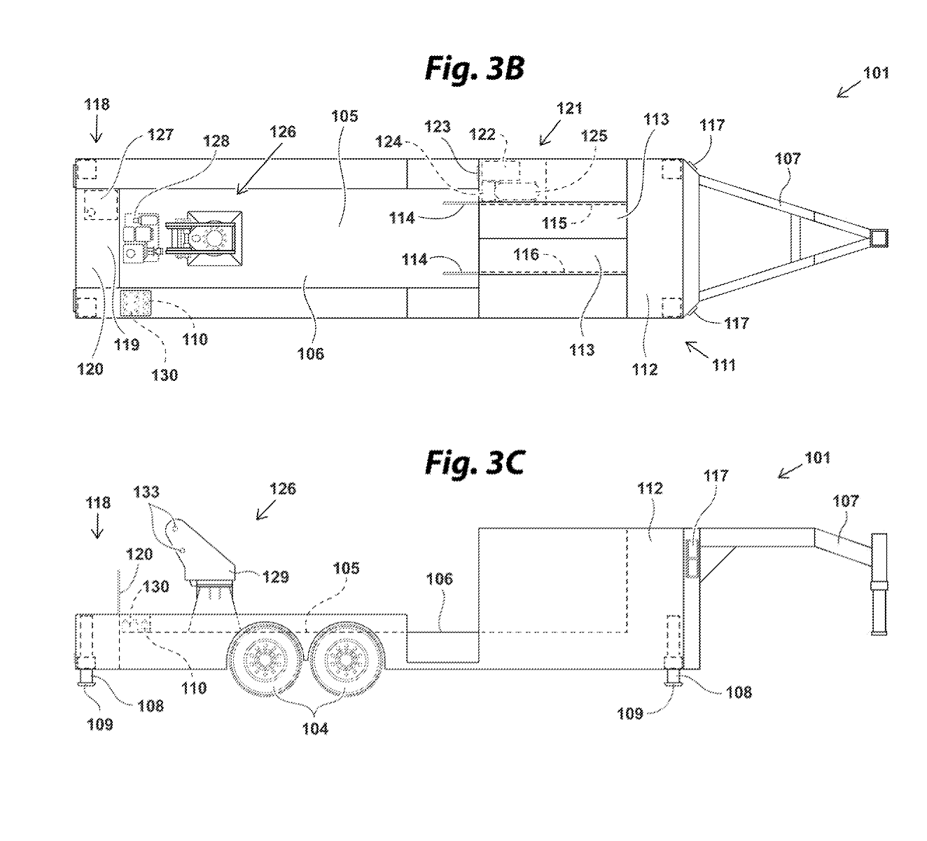

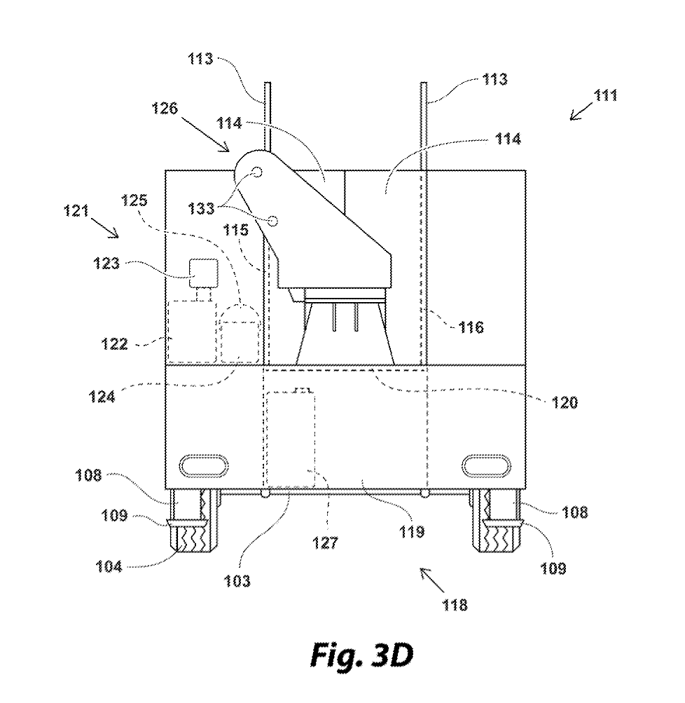

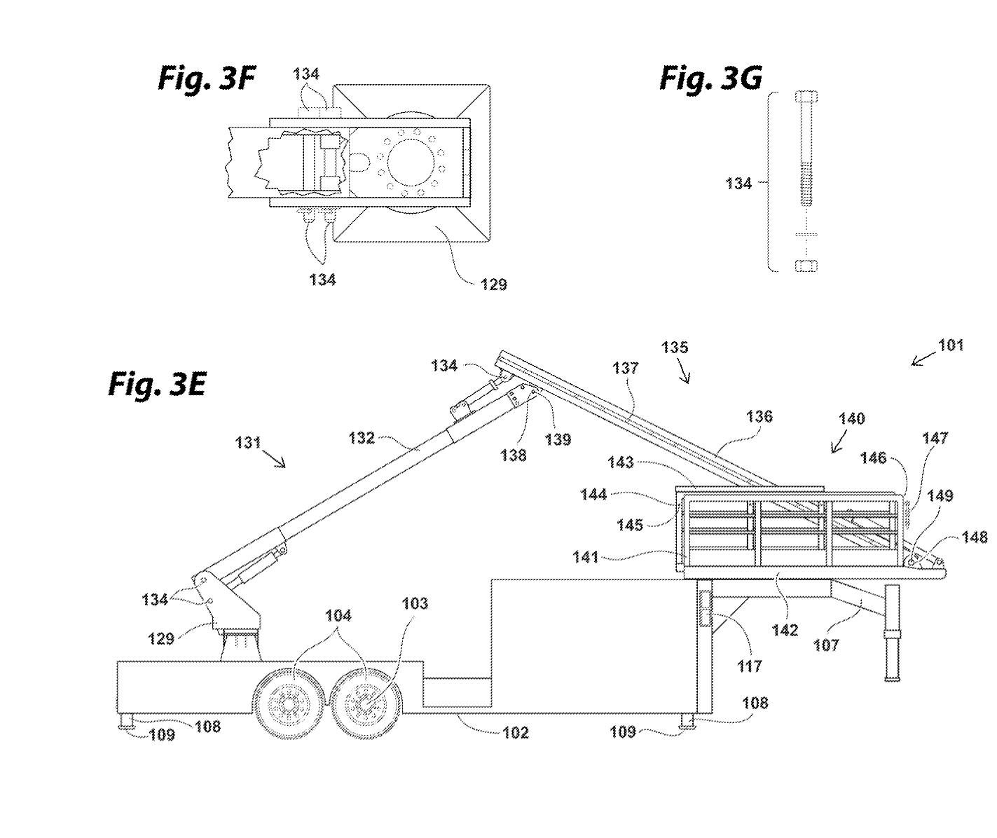

Referring to FIGS. 3A, 3B, 3C, 3D, 3E, 3F, and 3G, the unique built-in-pneumatic-tool-compressor on-site-extendable-interchangeable-boom on-site-extendable-interchangeable-ladder on-site-extendable-interchangeable-catwalk roadworthy-wheel-and-tire trailer comprises:

1) A roadworthy independently-adjustable-corner-height boom trailer system 101, comprising:
2) A trailer chassis 102,
3) Wheel axles 103,
4) Multiple wheels and tires 104,
5) An anti-slip safety deck 105,
6) An anti-slip safety coating 106,
7) Adjustable towing goose-neck tongue 107,
8) Four independently-adjustable trailer-leveling motorized legs 108,
9) Four motorized-leg bases 109,
10) A motorized-leg remote control 110;
11) A front utility watertight vault system 111, comprising:
12) A front utility watertight vault 112,
13) Lockable top-safety-access watertight doors 113,
14) Lockable interior-safety-access watertight doors 114,
15) Lockable left-safety-access watertight doors 115,
16) Lockable right-safety-access watertight doors 116,
17) Stop-and-go-indicator safety lights 117;
18) A rear utility watertight vault system 118, comprising:
19) A rear utility watertight vault 119,
20) Lockable rear-safety-access watertight door 120;
21) A convenient pneumatic-tool compressor system 121, comprising:
22) A convenient-pneumatic-tool fuel tank 122,
23) A convenient-pneumatic-tool fuel-filler 123,
24) A convenient-pneumatic-tool generator 124,
25) A convenient-pneumatic-tool compressor 125;
26) A stabilized quick-action turret system 126, comprising:
27) A quick-action-turret fuel tank 127,
28) A quick-action-turret motor 128,
29) A quick-action-turret assembly 129,
30) A quick-action-turret remote control 130;
31) Extendable interchangeable quick-release boom system 131, comprising:
32) An extendable interchangeable quick-release boom assembly 132,
33) Quick-release-boom-assembly pin holes 133,
34) Quick-release-boom-assembly pins 134;
35) Extendable interchangeable quick-release safety-cable-rung ladder system 135, comprising:
36) An extendable interchangeable quick-release ladder assembly 136,
37) Safety-cable-attaching rungs 137,
38) Quick-release-ladder-assembly pin holes 138,
39) Quick-release-ladder-assembly pins 139; and
40) Extendable interchangeable telescopic-safety-handrail catwalk system 140, comprising:
41) An extendable interchangeable anti-slip-grid catwalk assembly 141,
42) Safety footwalls 142,
43) Telescopic safety-handrail assembly 143,
44) Telescopic-safety-handrail-assembly adjustable holes 144,
45) Telescopic-safety-handrail-assembly adjustable pins 145,
46) Telescopic-safety-handrail-catwalk-assembly entry 146,
47) Telescopic-safety-handrail-catwalk-assembly chain 147;
48) Quick-release-catwalk-assembly pin holes 148,
49) Quick-release-catwalk-assembly pins 149.

### Material

### Referring to FIGS. 3A, 3B, 3C, 3D, 3E, 3F, and 3G:

1) Roadworthy independently-adjustable-corner-height boom trailer system 101 is made of combined materials of its components.
2) Trailer chassis 102 is made of metallic material.
3) Wheels axles 103 each are made of metallic material.
4) Multiple wheels and tires 104 each are made of metallic and rubber materials.
5) Anti-slip safety deck 105 is made of metallic material.
6) Anti-slip safety coating 106 is made of abrasive granular material.
7) Adjustable towing goose-neck tongue 107 is made of metallic material.
8) Four independently-adjustable trailer-leveling motorized legs 108 each are made of metallic material.
9) Four motorized-leg bases 109 each are made of metallic material.
10) Motorized-leg remote control 110 is made of metallic and plastic materials.
11) Front utility watertight vault system 111 is made of combined materials of its components.
12) Front utility watertight vault 112 is made of metallic material.
13) Lockable top-safety-access watertight doors 113 each are made of metallic material.
14) Lockable interior-safety-access watertight doors 114 each are made of metallic material.
15) Lockable left-safety-access watertight doors 115 are made of metallic material.
16) Lockable right-safety-access watertight doors 116 each are made of metallic material.
17) Stop-and-go-indicator safety lights 117 each are made of plastic, glass, and metallic materials.
18) Rear utility watertight vault system 118 is made of combined materials of its components.
19) Rear utility watertight vault 119 is made of metallic material.
20) Lockable rear-safety-access watertight door 120 is made of metallic material.
21) Convenient pneumatic-tool compressor system 121 is made of combined materials of its components.
22) Convenient-pneumatic-tool fuel tank 122 is made of metallic material.
23) Convenient-pneumatic-tool fuel-filler 123 is made of metallic material.
24) Convenient-pneumatic-tool generator 124 is made of metallic material.
25) Convenient-pneumatic-tool compressor 125 is made of metallic material.
26) Stabilized quick-action turret system 126 is made of combined materials of its components.
27) Quick-action-turret fuel tank 127 is made of metallic material.
28) Quick-action-turret motor 128 is made of metallic material.
29) Quick-action-turret assembly 129 is made of metallic material.
30) Quick-action-turret remote control 130 is made of metallic material.
31) Extendable interchangeable quick-release boom system 131 is made of combined materials of its components.
32) Extendable interchangeable quick-release boom assembly 132 is made of metallic material.
33) Quick-release-boom-assembly pin holes 133 each are made of empty space.
34) Quick-release-boom-assembly pins 134 each are made of metallic material.
35) Extendable interchangeable quick-release safety-cable-rung ladder system 135 is made of combined materials of its components.
36) Extendable interchangeable quick-release ladder assembly 136 is made of metallic material.
37) Safety-cable-attaching rungs 137 each are made of metallic material.
38) Quick-release-ladder-assembly pin holes 138 each are made of empty space.
39) Quick-release-ladder-assembly pins 139 each are made of metallic material.
40) Extendable interchangeable telescopic-safety-handrail catwalk system 140 is made of combined materials of its components.
41) Extendable interchangeable anti-slip-grid catwalk assembly 141 is made of metallic material.
42) Safety footwalls 142 each are made of metallic material.
43) Telescopic safety-handrail assembly 143 is made of metallic material.
44) Telescopic-safety-handrail-assembly adjustable holes 144 each are made of empty space.
45) Telescopic-safety-handrail-assembly adjustable pins 145 each are made of metallic material.
46) Telescopic-safety-handrail-catwalk-assembly entry 146 is made of empty space.
47) Telescopic-safety-handrail-catwalk-assembly chain 147 is made of metallic material;
48) Quick-release-catwalk-assembly pin holes 148 each are made of empty space.
49) Quick-release-catwalk-assembly pins 149 each are made of metallic material.

### Shape

Referring to FIGS. 3A, 3B, 3C, 3D, 3E, 3F, and 3G:
1) A roadworthy independently-adjustable-corner-height boom trailer system 101 has a combined shape of its components.
2) Trailer chassis 102 has a rectangular shape.
3) Wheels axles 103 each have a cylindrical shape.
4) Multiple wheels and tires 104 each have a circular shape.
5) Anti-slip safety deck 105 has a rectangular shape.
6) Anti-slip safety coating 106 has a flat shape.
7) Adjustable towing goose-neck tongue 107 has a triangular goose-neck shape.
8) Four independently-adjustable trailer-leveling motorized legs 108 each have an elongated shape with a square cross-section.
9) Four motorized-leg bases 109 each have a square shape.
10) A motorized-leg remote control 110 has a rectangular shape.
11) A front utility watertight vault system 111 has a combined shape of its components.
12) A front utility watertight vault 112 has a U shape.
13) Lockable top-safety-access watertight doors 113 each have a rectangular shape.
14) Lockable interior-safety-access watertight doors 114 each have a rectangular shape.
15) Lockable left-safety-access watertight doors 115 each have a rectangular shape.
16) Lockable right-safety-access watertight doors 116 each have a rectangular shape.
17) Stop-and-go-indicator safety lights 117 each have a rectangular shape.
18) A rear utility watertight vault system 118 has a combined shape of its components.
19) A rear utility watertight vault 119 has a rectangular shape.
20) Lockable rear-safety-access watertight door 120 has a rectangular shape.
21) A convenient pneumatic-tool compressor system 121 has a combined shape of its components.
22) A convenient-pneumatic-tool fuel tank 122 has a rectangular shape.
23) A convenient-pneumatic-tool fuel-filler 123 has a circular-tube shape.
24) A convenient-pneumatic-tool generator 124 has a cylindrical shape.
25) A convenient-pneumatic-tool compressor 125 has a cylindrical shape.
26) A stabilized quick-action turret system 126 has a combined shape of its components.
27) A quick-action-turret fuel tank 127 has a rectangular shape.
28) A quick-action-turret motor 128 has a cylindrical shape.
29) A quick-action-turret assembly 129 has a frustum shape.
30) A quick-action-turret remote control 130 has a rectangular shape.
31) Extendable interchangeable quick-release boom system 131 has a combined shape of its components.
32) An extendable interchangeable quick-release boom assembly 132 has an elongated shape.
33) Quick-release-boom-assembly pin holes 133 each have a round shape.
34) Quick-release-boom-assembly pins 134 each have a rod shape.
35) Extendable interchangeable quick-release safety-cable-rung ladder system 135 has a combined shape of its components.
36) An extendable interchangeable quick-release ladder assembly 136 has an elongated rectangular shape.
37) Safety-cable-attaching rungs 137 each have a cylindrical shape.
38) Quick-release-ladder-assembly pin holes 138 each have a round shape.
39) Quick-release-ladder-assembly pins 139 each have a rod shape.
40) An extendable interchangeable telescopic-safety-handrail catwalk system 140 has a combined shape of its components.
41) An extendable interchangeable anti-slip-grid catwalk assembly 141 has a rectangular shape.
42) Safety footwalls 142 each have a rectangular shape.
43) Telescopic safety-handrail assembly 143 has a telescopic U shape.
44) Telescopic-safety-handrail-assembly adjustable holes 144 each have a round shape.
45) Telescopic-safety-handrail-assembly adjustable pins 145 each have a rod shape.
46) Telescopic-safety-handrail-catwalk-assembly entry 146 has a rectangular shape.
47) Telescopic-safety-handrail-catwalk-assembly chain 147 has a chain shape.
48) Quick-release-catwalk-assembly pin holes 148 each have a round shape.
49) Quick-release-catwalk-assembly pins 149 each have a rod shape.

### Connection

### Referring to FIGS. 3A, 3B, 3C, 3D, 3E, 3F, and 3G:

1) Roadworthy independently-adjustable-corner-height boom trailer system 101 is attached to front utility watertight vault system 111 and rear utility watertight vault system 118.
2) Trailer chassis 102 is attached to wheels axles 103.
3) Wheel axles 103 each are rotatably attached to the underside of trailer chassis 102.
4) Multiple wheels and tires 104 each are rotatably bolted to wheel axles 103.
5) Anti-slip safety deck 105 is welded to the upper side of trailer chassis 102.
6) Anti-slip safety coating 106 is adhered to anti-slip safety deck 105.
7) Adjustable towing goose-neck tongue 107 is welded to the front of trailer chassis 102.
8) Four independently-adjustable trailer-leveling motorized legs 108 each are telescopically attached to one corner of the underside of trailer chassis 102.
9) Four motorized-leg bases 109 each are welded to one independently-adjustable trailer-leveling motorized leg 108.
10) Motorized-leg remote control 110 is attached to trailer chassis 102.
11) Front utility watertight vault system 111 is attached to trailer chassis 102.
12) Front utility watertight vault 112 is welded to trailer chassis 102.
13) Lockable top-safety-access watertight doors 113 each are hingedly connected to front utility watertight vault 112.
14) Lockable interior-safety-access watertight doors 114 each are hingedly connected to front utility watertight vault 112.
15) Lockable left-safety-access watertight doors 115 each are hingedly connected to front utility watertight vault 112.
16) Lockable right-safety-access watertight doors 116 each are hingedly connected to front utility watertight vault 112.
17) Stop-and-go-indicator safety lights 117 each are attached to front utility watertight vault 112.
18) Rear utility watertight vault system 118 is attached to trailer chassis 102.
19) Rear utility watertight vault 119 is welded to trailer chassis 102.
20) Lockable rear-safety-access watertight door 120 is hingedly connected to rear utility watertight vault 119.
21) Convenient pneumatic-tool compressor system 121 is attached to trailer chassis 102.
22) Convenient-pneumatic-tool fuel tank 122 is attached to trailer chassis 102.
23) Convenient-pneumatic-tool fuel-filler 123 is seamlessly attached to trailer system 101 or vault system 111 on driver's side for safety when refueling fuel tank 122.
24) Convenient-pneumatic-tool generator 124 is attached to trailer chassis 102.
25) Convenient-pneumatic-tool compressor 125 is attached to trailer chassis 102.
26) Stabilized quick-action turret system 126 is attached to trailer chassis 102.
27) Quick-action-turret fuel tank 127 is attached to trailer chassis 102.
28) Quick-action-turret motor 128 is attached to trailer chassis 102.
29) Quick-action-turret assembly 129 is rotatably attached to trailer chassis 102 and quick-action-turret motor 128.
30) Quick-action-turret remote control 130 is attached to quick-action-turret assembly 129 or trailer chassis 102.
31) Extendable interchangeable quick-release boom system 131 is interchangeably attached to stabilized quick-action turret system 126.
32) Extendable interchangeable quick-release boom assembly 132 is interchangeably attached to quick-action-turret assembly 129.
33) Quick-release-boom-assembly pin holes 133 each are drilled into one end of extendable interchangeable quick-release boom assembly 132.
34) Quick-release-boom-assembly pins 134 each are inserted through one quick-release-boom-assembly pin hole 133.
35) Extendable interchangeable quick-release safety-cable-rung ladder system 135 is interchangeably attached to extendable interchangeable quick-release boom system 131.
36) Extendable interchangeable quick-release ladder assembly 136 is interchangeably attached to another end of extendable interchangeable quick-release boom assembly 132.
37) Safety-cable-attaching rungs 137 each are welded to extendable interchangeable quick-release ladder assembly 136.
38) Quick-release-ladder-assembly pin holes 138 each are drilled into one end of extendable interchangeable quick-release ladder assembly 136.
39) Quick-release-ladder-assembly pins 139 each are inserted through one quick-release-ladder-assembly pin hole 138.
40) Extendable interchangeable telescopic-safety-handrail catwalk system 140 is interchangeably attached to extendable interchangeable quick-release safety-cable-rung ladder system 135.
41) Extendable interchangeable anti-slip-grid catwalk assembly 141 is attached to extendable interchangeable quick-release ladder assembly 136.
42) Safety footwalls 142 each are welded to the floor perimeter of extendable interchangeable anti-slip-grid catwalk assembly 141.
43) Telescopic safety-handrail assembly 143 is telescopically and adjustably connected to extendable interchangeable anti-slip-grid catwalk assembly 141.
44) Telescopic-safety-handrail-assembly adjustable holes 144 each are drilled into telescopic safety-handrail assembly 143.
45) Telescopic-safety-handrail-assembly adjustable pins 145 each are inserted through one telescopic-safety-handrail-assembly adjustable hole 144.
46) Telescopic-safety-handrail-catwalk-assembly entry 146 is built into extendable interchangeable anti-slip-grid catwalk assembly 141.
47) Telescopic-safety-handrail-catwalk-assembly chain 147 is attached to one side of telescopic-safety-handrail-catwalk-assembly entry 146.
48) Quick-release-catwalk-assembly pin holes 148 each are drilled into one end of extendable interchangeable anti-slip-grid catwalk assembly 141.
49) Quick-release-catwalk-assembly pins 149 each are inserted through one quick-release-catwalk-assembly pin hole 148.

### Function

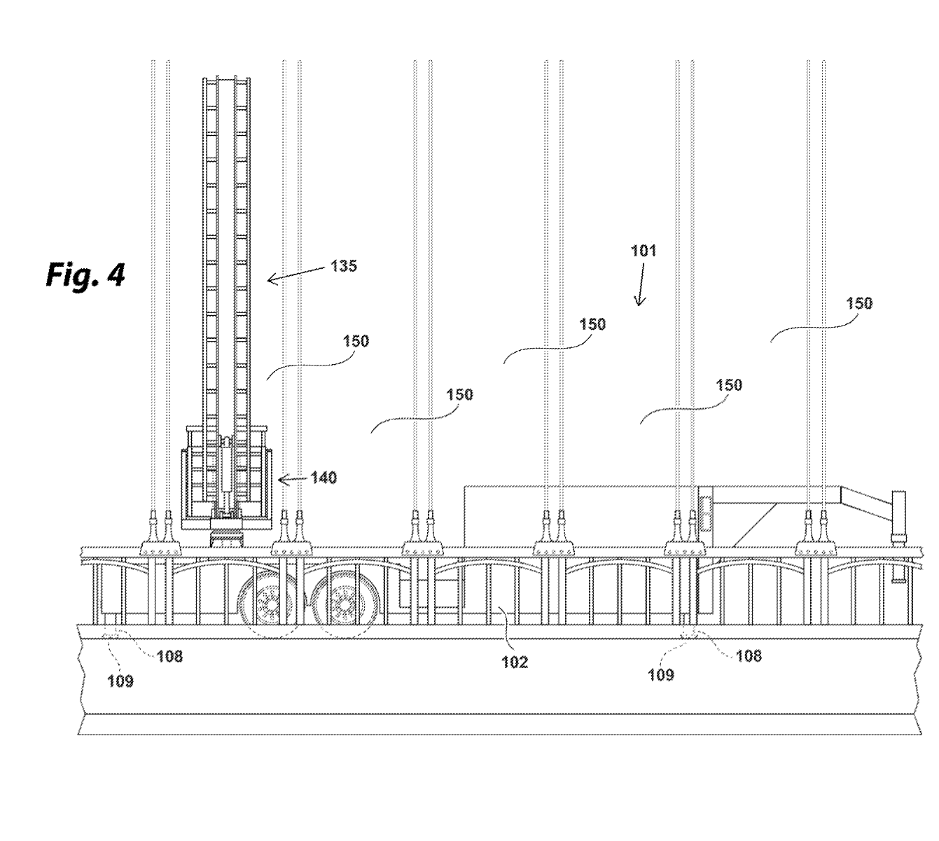

### Referring to FIGS. 4, 5, 6A, 6B, 7A, and 7B:

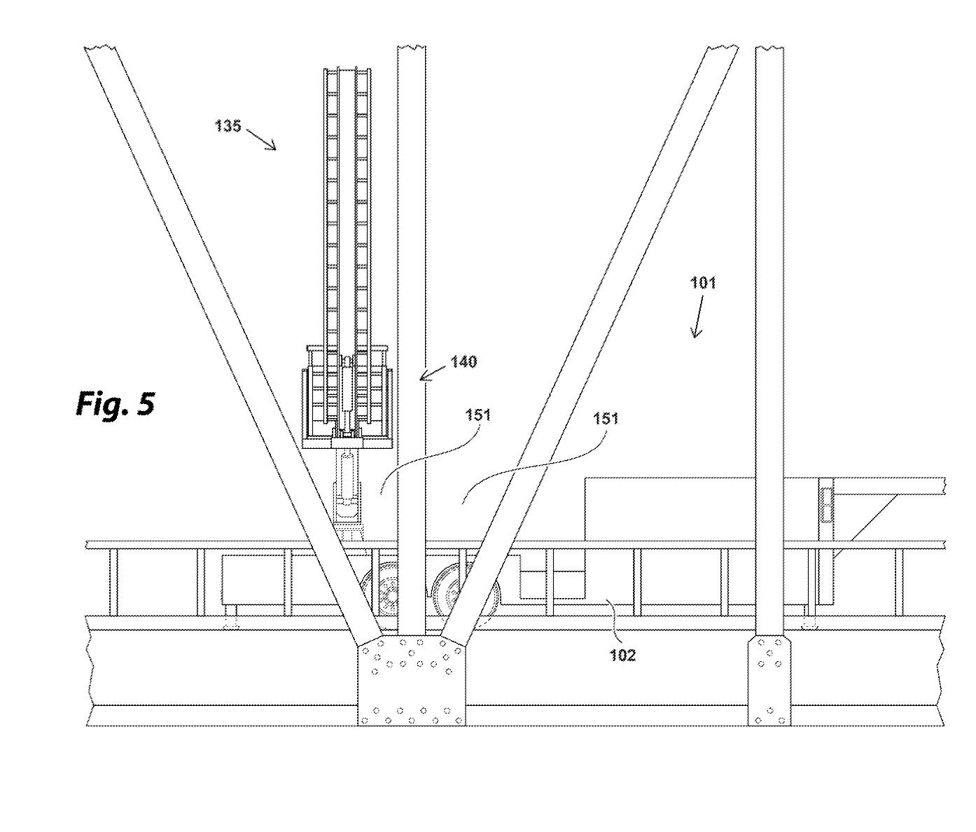

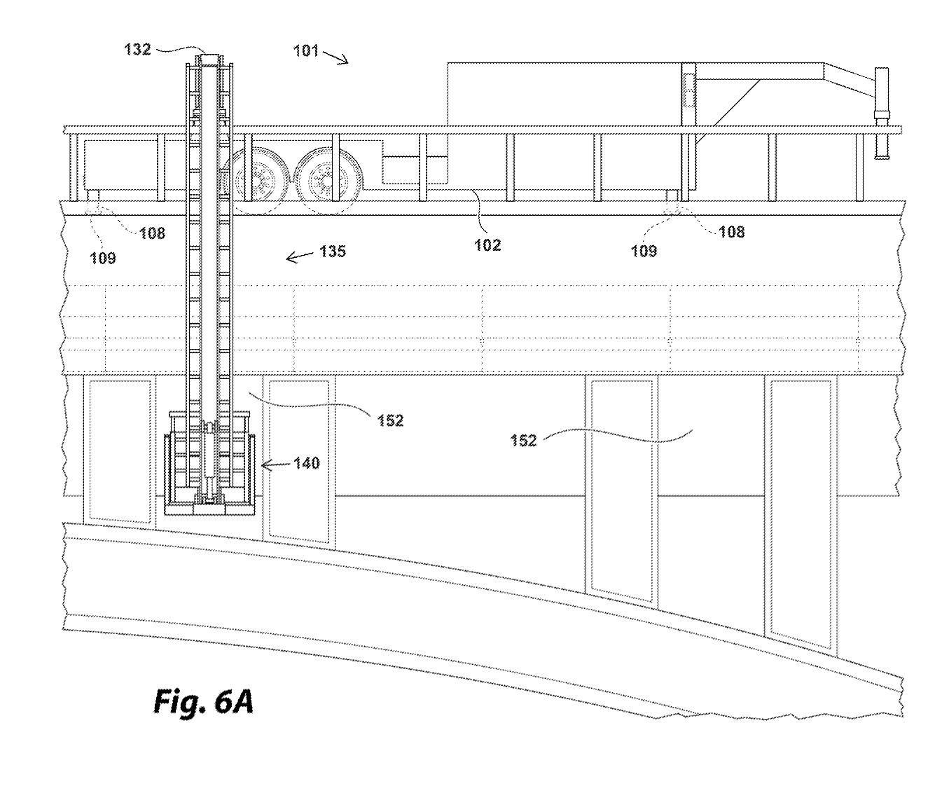

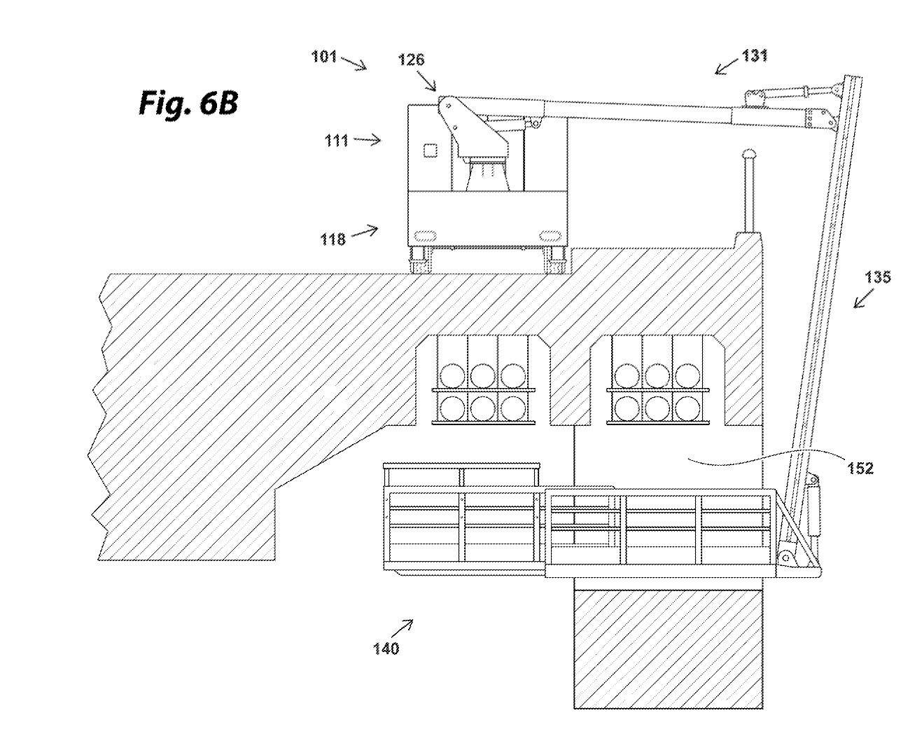

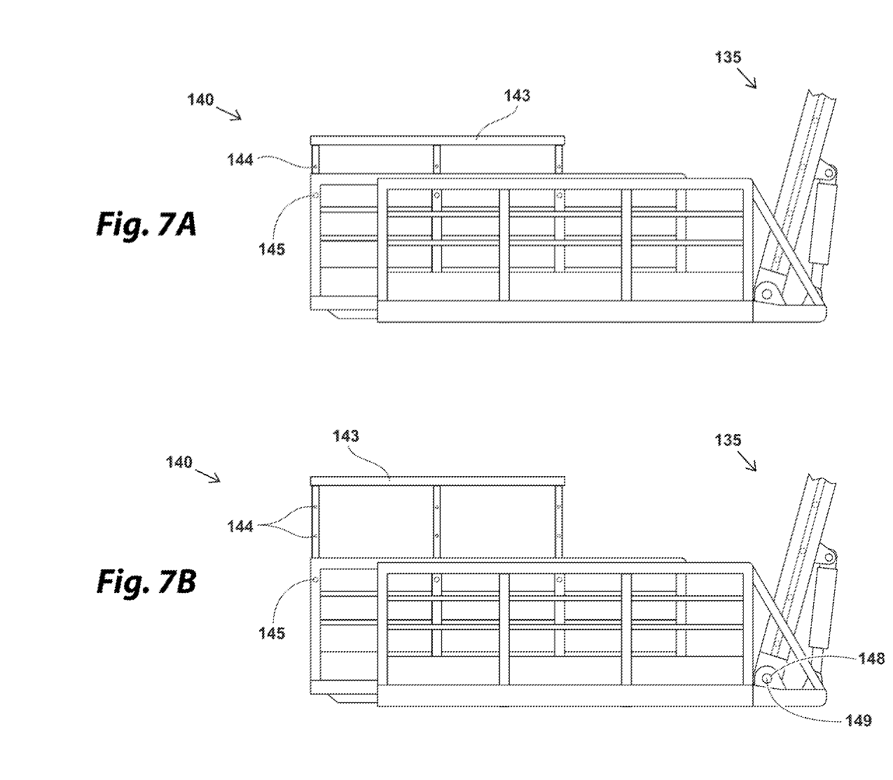

1) Roadworthy independently-adjustable-corner-height boom trailer system 101 is for:
   a) Providing a roadworthy, compact, and stable platform to securely mount thereon and conveniently transport extendable interchangeable quick-release boom system 131, extendable interchangeable quick-release safety-cable-rung ladder system 135, and extendable interchangeable telescopic-safety-handrail catwalk system 140, which can lift and shift equipment and personnel through narrow openings over and under bridges (for example, through a less-than-30-inch-wide opening 150 between two cables of a small suspension-cable-type bridge (FIG. 4) or through a less-than-30-inch-wide opening 151 between two posts of a small truss-type bridge (FIG. 5), and can maneuver and work in small areas, nooks, and crannies (for example, in a less-than-30-inch-wide nook 152 (FIGS. 6A and 6B) over and under:
      small and large suspension-cable-type bridges (suspension bridges),
      small and large truss-type bridges,
      small and large low-power-line bridges,
      small and large high-power-line bridges,
      small and large short-supporting-column bridges,
      small and large tall-supporting-column bridges,
      small and large single-lane bridges,
      small and large multiple-lane bridges,
      small and large regular bridges, and
      small and large rail-road bridges;
   b) Providing a platform with four independently-adjustable trailer-leveling motorized legs 108 to level trailer chassis 102 when situated on uneven terrain (FIG. 6A); c) Providing motorized-leg remote control 110; and
   d) Providing a safe, non-slip working platform.
2) Trailer chassis 102 is for providing a platform upon which stabilized quick-action turret system 126 can be securely mounted.
3) Wheels axles 103 each are for rotatably securing multiple wheels and tires 104 to trailer chassis 102.
4) Multiple wheels and tires 104 each are for allowing roadworthy independently-adjustable-corner-height boom trailer system 101 to move on a road.
5) Anti-slip safety deck 105 is for providing a safe, convenient working area.
6) Anti-slip safety coating 106 is for providing a safe, non-slip working surface.
7) Adjustable towing goose-neck tongue 107 is for attaching trailer chassis 102 to a motorized vehicle.
8) Four independently-adjustable trailer-leveling motorized legs 108 each are for independently providing adjustable height, to level trailer chassis 102 when situated on uneven terrain.
9) Four motorized-leg bases 109 each are for providing a stable base on the ground for one of four independently-adjustable trailer-leveling motorized legs 108.
10) Motorized-leg remote control 110 is for conveniently adjusting the height of independently-adjustable trailer-leveling motorized legs 108.
11) Front utility watertight vault system 111 is for:
   a) Providing safe interior access to tools and equipment, away from traffic, and
   b) Providing locked water-tight storage for tools and equipment.
12) Front utility watertight vault 112 is for providing safe interior access to tools and equipment away from traffic.
13) Lockable top-safety-access watertight doors 113 each are for providing a lockable, water-tight barrier, and a safe, convenient working surface.
14) Lockable interior-safety-access watertight doors 114 each are for providing a lockable, water-tight barrier, and a safe, convenient working surface.
15) Lockable left-safety-access watertight doors 115 each are for providing a lockable, water-tight barrier, and a safe, convenient working surface.
16) Lockable right-safety-access watertight doors 116 each are for providing a lockable, water-tight barrier, and a safe, convenient working surface.
17) Stop-and-go-indicator safety lights 117 each are for providing a safe, clear communication means for vehicle movement readiness between boom operator and driver.
18) Rear utility watertight vault system 118 is for:
   a) Providing safe interior access to tools and equipment, away from traffic, and
   b) Providing locked water-tight storage for tools and equipment.
19) Rear utility watertight vault 119 is providing safe access to tools and equipment.
20) Lockable rear-safety-access watertight door 120 is for providing a lockable, water-tight barrier, and a safe, convenient working surface.
21) Convenient pneumatic-tool compressor system 121 is for providing convenient, on-board compressed air to operate pneumatic tools.
22) Convenient-pneumatic-tool fuel tank 122 is for holding fuel for convenient-pneumatic-tool generator 124.
23) Convenient-pneumatic-tool fuel-filler 123 is for providing safe, convenient access for filling convenient-pneumatic-tool fuel tank 122.
24) Convenient-pneumatic-tool generator 124 is for providing electricity for operating convenient-pneumatic-tool compressor 125.
25) Convenient-pneumatic-tool compressor 125 is for providing compressed air for operating pneumatic-tools.
26) Stabilized quick-action turret system 126 is for anchoring extendable interchangeable quick-release boom system 131, extendable interchangeable quick-release safety-cable-rung ladder system 135, and extendable interchangeable telescopic-safety-handrail catwalk system 140 to trailer chassis 102, and for rotating them.
27) Quick-action-turret fuel tank 127 is for holding fuel for quick-action-turret motor 128.
28) Quick-action-turret motor 128 is for rotating quick-action-turret assembly 129.
29) Quick-action-turret assembly 129 is for rotating extendable interchangeable quick-release boom system 131, extendable interchangeable quick-release safety-cable-rung ladder system 135, and extendable interchangeable telescopic-safety-handrail catwalk system 140.
30) Quick-action-turret remote control 130 is for conveniently controlling the rotation of extendable interchangeable quick-release boom system 131, extendable interchangeable quick-release safety-cable-rung ladder system 135, and extendable interchangeable telescopic-safety-handrail catwalk system 140.
31) Extendable interchangeable quick-release boom system 131 is for:
   a) Coupling quick-action-turret assembly 129 to extendable interchangeable quick-release ladder assembly 136, and
   b) Extending the reach of extendable interchangeable quick-release ladder assembly 136.
32) Extendable interchangeable quick-release boom assembly 132 is for extending the reach of and enabling the movement of extendable interchangeable quick-release ladder assembly 136.
33) Quick-release-boom-assembly pin holes 133 each are for one quick-release-boom-assembly pin 134 to be inserted therethrough.
34) Quick-release-boom-assembly pins 134 each are for being inserted through one quick-release-boom-assembly pin hole 133 to quickly and releasably couple quick-action-turret assembly 129 to extendable interchangeable quick-release boom assembly 132, to provide convenient on-site interchangeability.
35) Extendable interchangeable quick-release safety-cable-rung ladder system 135 is for:
   a) Coupling extendable interchangeable quick-release boom assembly 132 to extendable interchangeable anti-slip-grid catwalk assembly 141, and
   b) Extending the reach of extendable interchangeable anti-slip-grid catwalk assembly 141.
36) Extendable interchangeable quick-release ladder assembly 136 is for extending the reach of and enabling the movement of extendable interchangeable anti-slip-grid catwalk assembly 141.
37) Safety-cable-attaching rungs 137 each are for safety cables, yoyos, fall arrest systems, and/or lanyards to be attached thereto for added safety and maneuverability of workers.
38) Quick-release-ladder-assembly pin holes 138 each are for one quick-release-ladder-assembly pin 139 to be inserted therethrough.
39) Quick-release-ladder-assembly pins 139 each are for being inserted through one quick-release-ladder-assembly pin hole 138, to quickly and releasably couple extendable interchangeable quick-release boom assembly 132 to extendable interchangeable quick-release ladder assembly 136, to provide convenient on-site interchangeability.
40) Extendable interchangeable telescopic-safety-handrail catwalk system 140 is for:
   a) Providing a telescopic, height-adjustable safety handrail,
   b) Providing a safe, anti-slip interchangeable working platform, and
   c) Providing safety barriers for feet, legs, and bodies.
41) Extendable interchangeable anti-slip-grid catwalk assembly 141 is for providing a safe, interchangeable working platform.
42) Safety footwalls 142 each are for providing a safety barrier.
43) Telescopic safety-handrail assembly 143 (FIGS. 7A and 7B) is for providing a height-adjustable safety handrail for workers to lean on and hold on while working, for added safety.
44) Telescopic-safety-handrail-assembly adjustable holes 144 each are for one telescopic-safety-handrail-assembly adjustable pin 145 to be inserted therethrough.
45) Telescopic-safety-handrail-assembly adjustable pins 145 each are for being inserted through one telescopic-safety-handrail-assembly adjustable hole 144 to adjust the height of telescopic safety-handrail assembly 143.
46) Telescopic-safety-handrail-catwalk-assembly entry 146 is for providing an easy entry into extendable interchangeable anti-slip-grid catwalk assembly 141.
47) Telescopic-safety-handrail-catwalk-assembly chain 147 is for providing a safety barrier.
48) Quick-release-catwalk-assembly pin holes 148 each are for one quick-release-catwalk-assembly pin 149 to be inserted therethrough.
49) Quick-release-catwalk-assembly pins 149 each are for being inserted through one quick-release-catwalk-assembly pin hole 148, to quickly and releasably couple extendable interchangeable quick-release ladder assembly 136 to extendable interchangeable anti-slip-grid catwalk assembly 141, to provide convenient on-site interchangeability.

### Operation

Referring to FIGS. 3A, 4, 5, 6A, 6B, 7A, and 7B, the unique built-in-pneumatic-tool-compressor on-site-extendable-interchangeable-boom on-site-extendable-interchangeable-ladder on-site-extendable-interchangeable-catwalk roadworthy-wheel-and-tire trailer, comprises:

### Bridge Maintenance

1) Towing the unique trailer to a:
   suspension-cable-type bridge,
   truss-type bridge,
   low-power-line bridge,
   high-power-line bridge,
   short-supporting-column bridge,
   tall-supporting-column bridge,
   single-lane bridge,
   multiple-lane bridge,
   regular bridge, or
   rail-road bridge;
2) Parking the unique trailer on the sidewalk 153 (FIG. 3A) of the bridge;
3) Adjusting independently-adjustable trailer-leveling motorized legs 108 to level the unique trailer;
4) Loading equipment, personnel, and bridge-maintenance goods on anti-slip safety deck 105;
5) Loading equipment, personnel, and bridge-maintenance goods in extendable interchangeable anti-slip-grid catwalk assembly 141;
6) Adjusting telescopic safety-handrail assembly 143 to a desired height for added safety;
7) Inserting telescopic-safety-handrail-assembly adjustable pins 145 though telescopic-safety-handrail-assembly adjustable holes 144;
8) Hooking safety cables to safety-cable-attaching rungs 137;
9) Turning on or off stop-and-go-indicator safety lights 117 for communication between personnel in catwalk assembly 141 and the driver of the unique trailer;
10) Rotating extendable interchangeable quick-release boom assembly 132 by using quick-action-turret assembly 129;
11) Shifting extendable interchangeable anti-slip-grid catwalk assembly 141 through small openings of the bridge (for example, through a less-than-30-inch-wide opening 150 between two cables of a small suspension-cable-type bridge (FIG. 4) or through a less-than-30-inch-wide opening 151 between two posts of a small truss-type bridge (FIG. 5);
12) Extending extendable interchangeable quick-release boom assembly 132;
13) Extending extendable interchangeable quick-release ladder assembly 136;
14) Extending extendable interchangeable anti-slip-grid catwalk assembly 141 (FIGS. 7A and 7B);
15) Shifting extendable interchangeable anti-slip-grid catwalk assembly 141 into nooks and crannies under the bridge (for example, in a less-than-30-inch-wide nook 152 under a bridge (FIGS. 6A and 6B); and
16) Running equipment with convenient-pneumatic-tool compressor 125 built in the unique trailer to maintain and service the bridge.

### Reconfiguration of Boom Assembly

1) Releasing quick-release-boom-assembly pins 134 from quick-release-boom-assembly pin holes 133;
2) Replacing extendable interchangeable quick-release boom assembly 132 with another boom assembly;
3) Securing quick-release-boom-assembly pins 134 through quick-release-boom-assembly pin holes 133.

### Reconfiguration of Ladder Assembly

1) Releasing quick-release-ladder-assembly pins 139 from quick-release-ladder-assembly pin holes 138;
2) Replacing extendable interchangeable quick-release ladder assembly 136 with another ladder assembly;
3) Securing quick-release-ladder-assembly pins 139 through quick-release-ladder-assembly pin holes 138.

### Reconfiguration of Catwalk Assembly

1) Releasing quick-release-catwalk-assembly pins 149 from quick-release-catwalk-assembly pin holes 148;
2) Replacing extendable interchangeable anti-slip-grid catwalk assembly 141 with another catwalk assembly;
3) Securing quick-release-catwalk-assembly pins 149 through quick-release-catwalk-assembly pin holes 148.

### Variation

Any of quick-release-boom-assembly pins 134, quick-release-ladder-assembly pins 139, telescopic-safety-handrail-assembly adjustable pins 145, quick-release-catwalk-assembly pins 149 can be replaced with a cotter pin, single-ball detent pin, double-ball detent pin, or an equivalent.

Quick-action-turret remote control 130 can be wireless such that quick-action-turret assembly 129 can be operated from a distance, for example, by personnel on extendable interchangeable anti-slip-grid catwalk assembly 141.

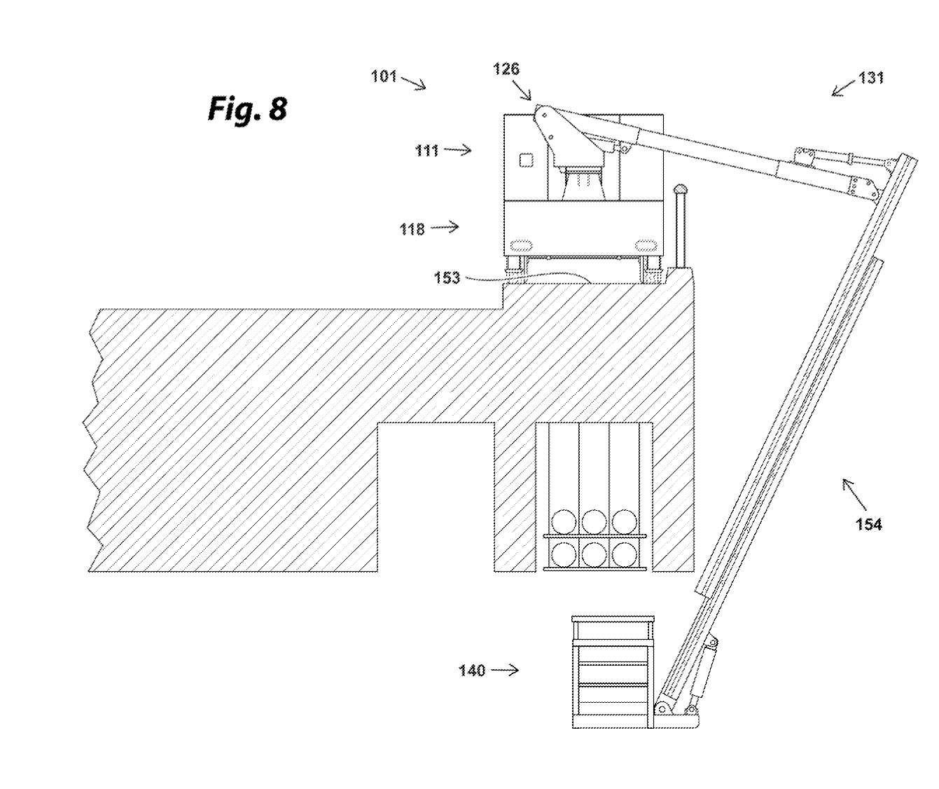

FIG. 8 illustrates an equivalent variation 154 of extendable interchangeable anti-slip-grid catwalk system 140.

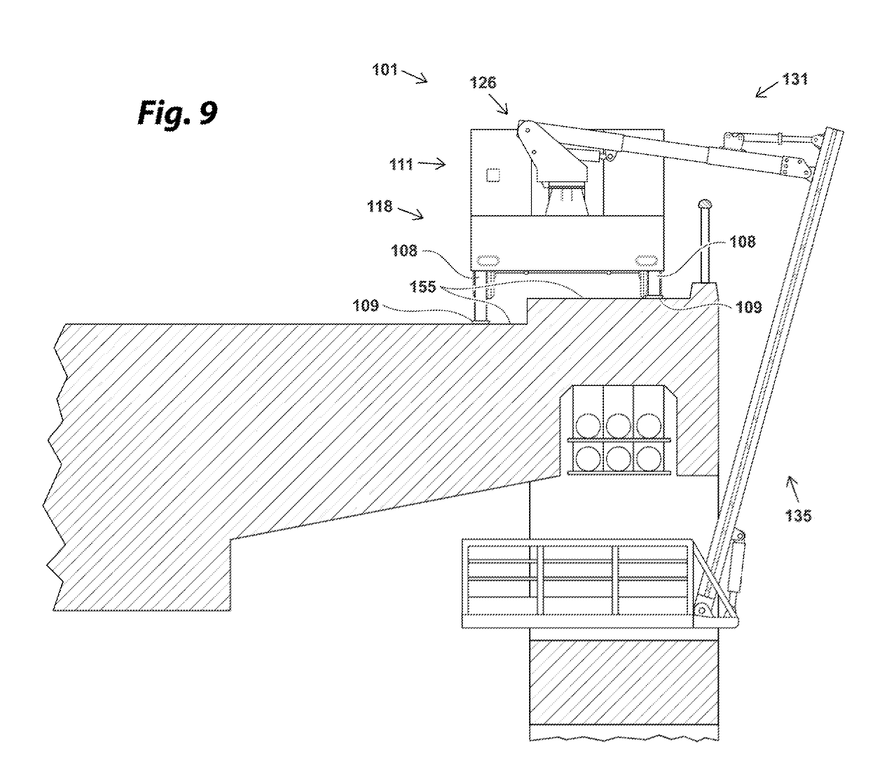

FIG. 9 illustrates how each of independently-adjustable trailer-leveling motorized legs 108 is independently adjusted to level the unique built-in-pneumatic-tool-compressor on-site-extendable-interchangeable-boom on-site-extendable-interchangeable-ladder on-site-extendable-interchangeable-catwalk roadworthy-wheel-and-tire trailer when the unique trailer is parked on an uneven surface 155 on a bridge.

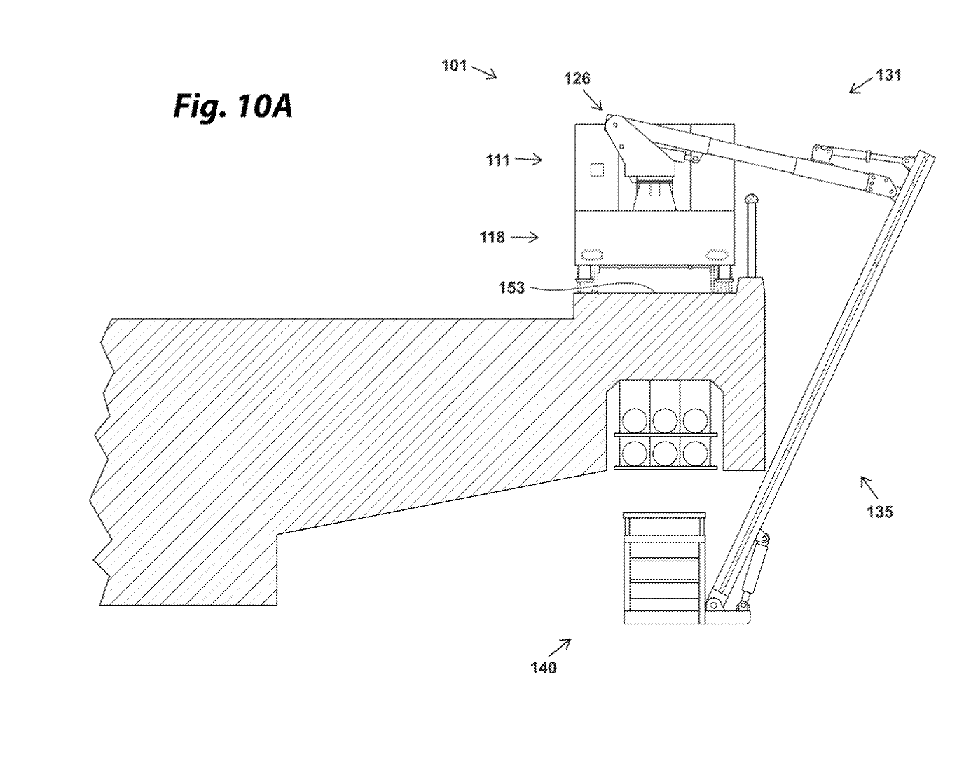

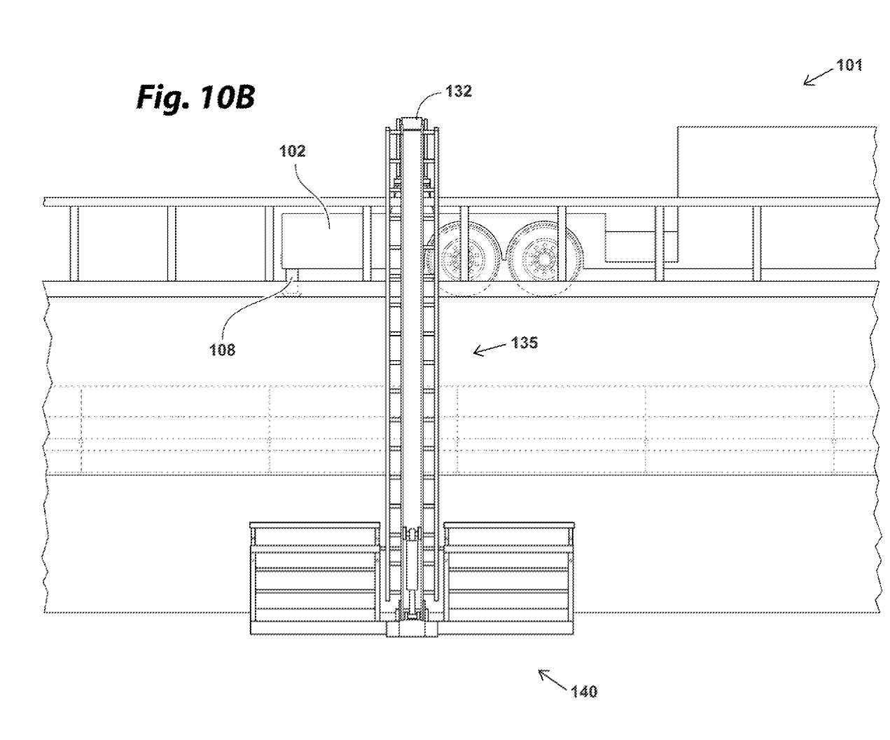

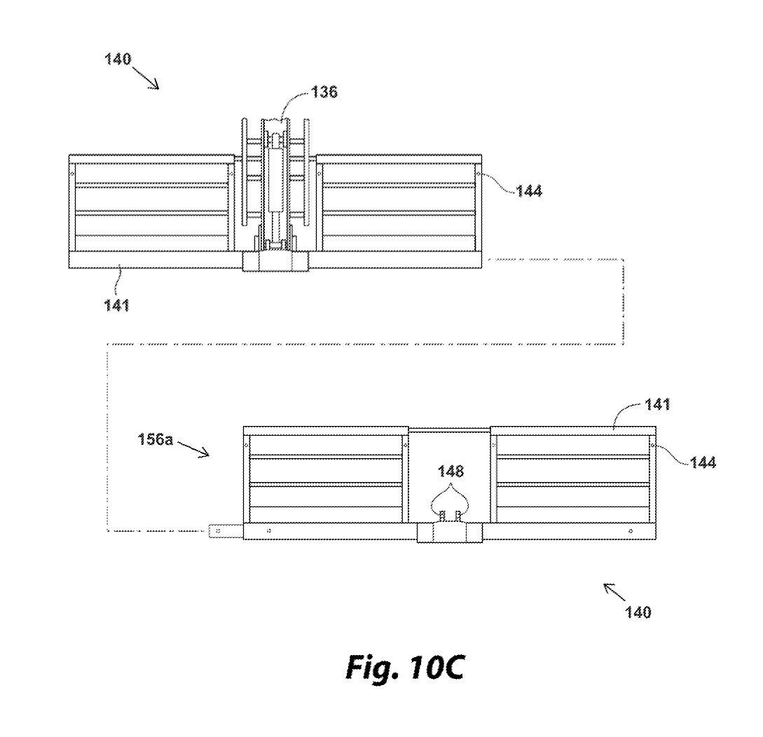

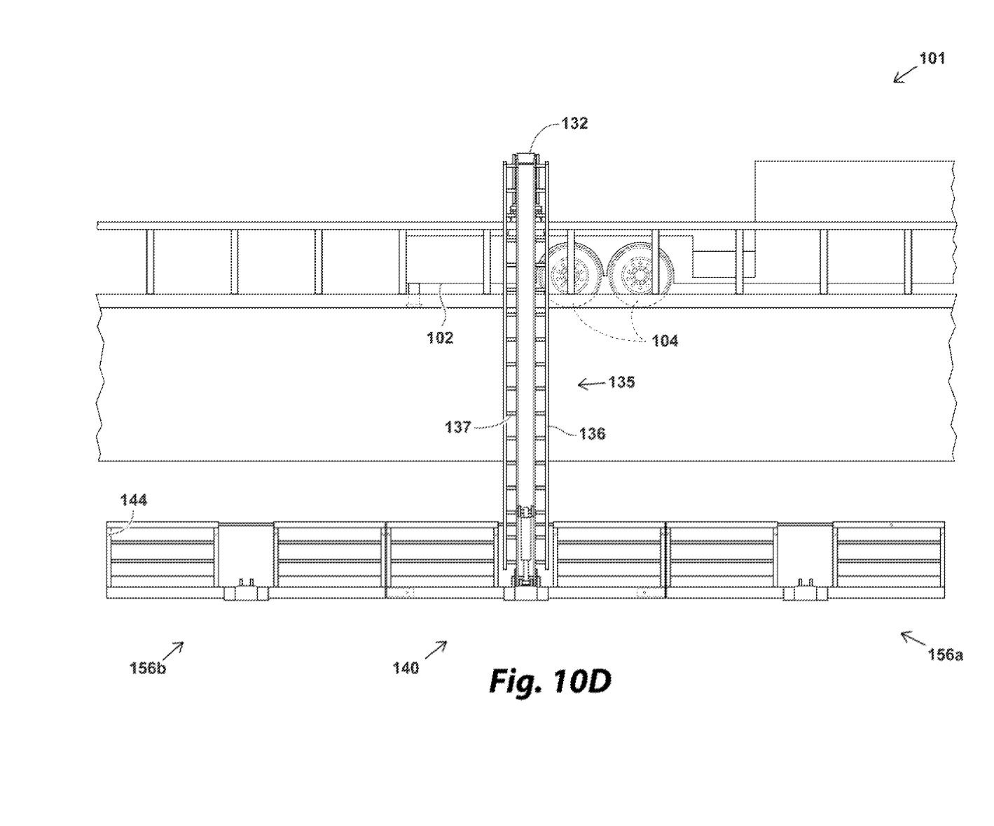

Referring to FIGS. 10A, 10B, 10C, and 10D, further, the unique built-in-pneumatic-tool-compressor on-site-extendable-interchangeable-boom on-site-extendable-interchangeable-ladder on-site-extendable-interchangeable-catwalk roadworthy-wheel-and-tire trailer can be parked on a sidewalk, and can comprise at least one additional extendable interchangeable anti-slip-grid catwalk system (for example, two additional extendable interchangeable anti-slip-grid catwalk systems 156a and 156b) to extend the width or length of extendable interchangeable anti-slip-grid catwalk system 140.

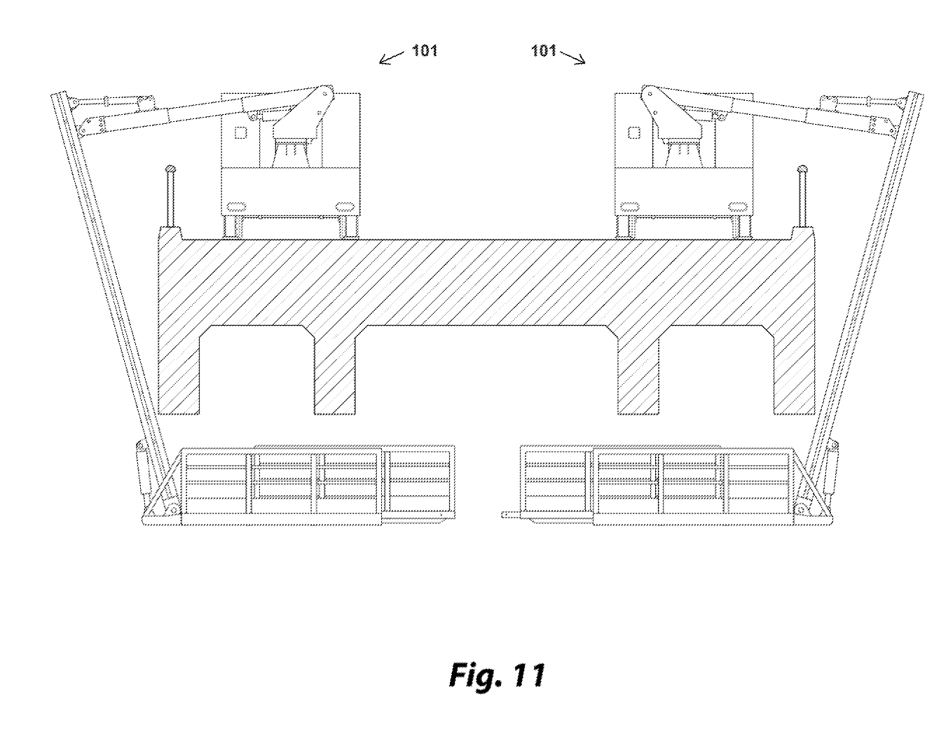

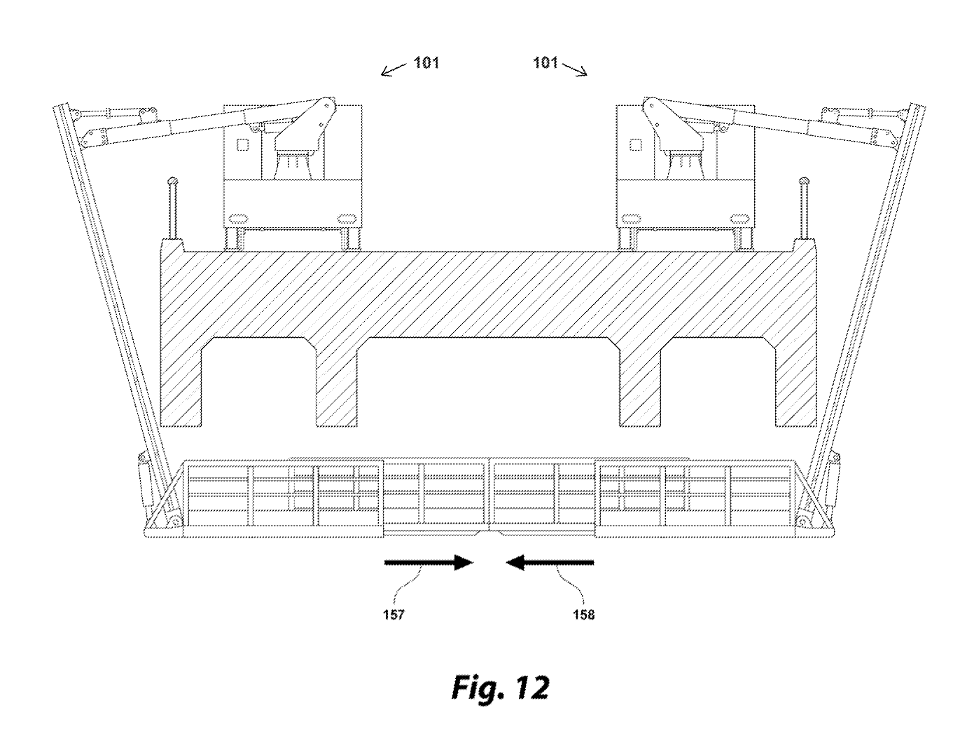

Referring to FIGS. 11 and 12, two extendable interchangeable anti-slip-grid catwalk systems, equivalent to extendable interchangeable anti-slip-grid catwalk system 140 can be coupled together under a bridge, in the opposite directions of arrows 157 and 158, such that their combined length equals the width of the bride to maintain and service the whole width of the bridge.

### Major Advantages of the Invention

The present invention substantially departs from the conventional concepts and designs of the prior art. In doing so, the present invention provides a unique built-in-pneumatic-tool-compressor on-site-extendable-interchangeable-boom on-site-extendable-interchangeable-ladder on-site-extendable-interchangeable-catwalk roadworthy-wheel-and-tire trailer, having many unique and significant features, functions, and advantages, which overcome all the disadvantages of the prior art, as follows:
1) It is an object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Can work on:
      small and large suspension-cable-type bridges (suspension bridges),
      small and large truss-type bridges,
      small and large low-power-line bridges,
      small and large high-power-line bridges,
      small and large short-supporting-column bridges,
      small and large tall-supporting-column bridges,
      small and large single-lane bridges,
      small and large multiple-lane bridges,
      small and large regular bridges, and
      small and large rail-road bridges;
   b) Has an extendable interchangeable quick-release boom assembly and an extendable interchangeable anti-slip-grid catwalk assembly, which can maneuver and work in small areas, nooks, and crannies under:
      small and large suspension-cable-type bridges (suspension bridges),
      small and large truss-type bridges,
      small and large low-power-line bridges,
      small and large high-power-line bridges,
      small and large short-supporting-column bridges,
      small and large tall-supporting-column bridges,
      small and large single-lane bridges,
      small and large multiple-lane bridges,
      small and large regular bridges, and
      small and large rail-road bridges;
   c) Has an extendable interchangeable quick-release boom assembly and an extendable interchangeable anti-slip-grid catwalk assembly, which:
      can lift and shift equipment and personnel through narrow openings over and under bridges (for example, through a less-than-30-inch-wide opening between two cables of a small suspension-cable-type bridge or between two posts of a small truss-type bridge),
      can lift and shift bridge-maintenance goods through narrow openings over and under bridges (for example, through a less-than-30-inch-wide opening between two cables of a small suspension-cable-type bridge or between two posts of a small truss-type bridge);
   d) Has four independently-adjustable trailer-leveling motorized legs for adjusting the height at the trailer's four corners, to level the trailer when situated on uneven terrain;
   e) Has roadworthy chassis, wheels, and tires such that the unique trailer can be towed at highway speed; and
   f) Can be sized to operate entirely within the width of a sidewalk.
2) It is another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Is able to be towed from one bridge to another, with its boom assembly, ladder assembly, and catwalk assembly pre-installed thereon,
   b) Eliminates the need for an extra roadworthy trailer to carry it from one bridge to another,
   c) Saves materials, production costs, labor, time, and money,
   d) Eliminates the need for loading it on a roadworthy trailer to carry it to a worksite,
   e) Eliminates the need for unloading it from a roadworthy trailer,
   f) Eliminates the need for assembling it,
   g) Eliminates the need for disassembling it, and
   h) Eliminates the need for loading it back on a roadworthy trailer to carry it to another worksite.
3) It is a further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Is compact, versatile, pre-installed, and ready for operation,
   b) Is cheap to operate and maintain,
   c) Can be towed by a small, affordable, regular truck, which does not require any special driving license to be operated,
   d) Eliminates the need for big, expensive, and specialized truck, and special driving license, and
   e) Reduces setup time, and saves time and money.
4) It is an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which, having its turret assembly permanently welded to its deck, and its boom assembly and catwalk assembly pre-installed:
   a) Provides stability,
   b) Eliminates the need for setting it up, and
   c) Saves setup labor and time.
5) It is another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has a low compact profile sticking up in the air,
   b) Can provide a safe working trailer, in the proximity of low power lines on bridges,
   c) Can deploy within a bridge sidewalk, and
   d) Can deploy within a bridge sidewalk and/or one traffic lane, with its compact boom and catwalk assembly never encroaching into the second traffic lane.
6) It is yet another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has vertically telescopic adjustable safety handrail on its catwalk or basket for workers to lean on and hold on while working, for added safety,
   b) Has safety rungs for safety cables, yoyos, fall arrest systems, and/or lanyards to be attached thereto for added safety and maneuverability of workers, and
   c) Prevents accidents and personal injuries, and saves time and money.
7) It is still yet another object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has extendable and interchangeable quick-release boom assembly (with quick-release pins for quick and easy reconfiguration while situated on a bridge) for specific bridge maintenances and services, to provide efficiency, to provide extended horizontal and vertical reaches, to save time, and to save bridge-maintenance-and-service costs,
   b) Has extendable and interchangeable quick-release ladder assembly (with quick-release pins for quick and easy reconfiguration while situated on a bridge) for specific bridge maintenances and services, to provide efficiency, to provide extended horizontal and vertical reaches, to save time, and to save bridge-maintenance-and-service costs, and
   c) Has extendable and interchangeable anti-slip-grid catwalk or basket assembly (with quick-release pins for quick and easy reconfiguration while situated on a bridge) for specific bridge maintenances and services, to provide efficiency, to provide extended horizontal and vertical reaches, to save time, and to save bridge-maintenance-and-service costs.
8) It is still yet an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has convenient built-in-pneumatic-tool compressor to run power tools,
   b) Has easily and safely accessible, walk-in utility vaults & utility storage, and
   c) Has hydraulic motor, pump, and tank located next to the turret assembly to allow for quick activation of the hydraulic system, and save materials, production costs, and money,
9) It is still yet an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has the turret control located to its catwalk or basket to be operated therefrom to prevent accidents and personal injuries, and to increase efficiency, and
   b) Has fuel filler located next to its sidewalk side to be easily accessible, to provide safety, convenience, and efficiency when refilling the unique trailer's fuel tank.
10) It is still yet an even further object of the present invention to provide the unique built-in-pneumatic-tool-compressor on-site-extendable-interchangeable-boom on-site-extendable-interchangeable-ladder on-site-extendable-interchangeable-catwalk roadworthy-wheel-and-tire trailer, which:
   a) Has its deck fully coated with anti-slip coating to prevent personal injuries, and
   b) Has angled stop-and-go lights relocated to its two front corners to allow both driver and worker see them to better communicate with each other to increase efficiency and to prevent personal injuries.

What is claimed is:

1. A roadworthy over-and-under-bridge-access boom trailer, for being towed on a road to eliminate the need for an extra trailer, for operating within the width of a sidewalk, and for lifting and shifting equipment and personnel through a narrow opening or into a nook over or under a bridge, comprising:
a roadworthy wheeled chassis having an upper side, an underside, and a plurality of corners;
an anti-slip deck welded to said upper side of said roadworthy wheeled chassis, said anti-slip deck having a front section and a rear section;
a plurality of independently-adjustable trailer-leveling motorized legs each telescopically attached to said underside of said roadworthy wheeled chassis at one of said corners;
a plurality of leg bases each attached to one of said motorized legs;
at least one front vault attached to said front section of said anti-slip deck;
a plurality of stop-and-go lights attached to said at least one front vault;
at least one rear vault attached to said rear section of said anti-slip deck;
a pneumatic-tool compressor assembly attached to said anti-slip deck;
a turret assembly rotatably attached to said anti-slip deck;
an extendable interchangeable boom assembly extendably and releasably attached to said turret assembly;
a quick-release boom-to-turret coupler attached to said extendable interchangeable boom assembly and said turret assembly;
an extendable interchangeable ladder assembly extendably and releasably attached to said extendable interchangeable boom assembly;
a quick-release ladder-to-boom coupler attached to said extendable interchangeable ladder assembly and said extendable interchangeable boom assembly;
a plurality of safety-cable-attaching rungs welded to said extendable interchangeable ladder assembly;
an extendable interchangeable catwalk assembly extendably and releasably attached to said extendable interchangeable ladder assembly;
a quick-release catwalk-to-ladder coupler attached to said extendable interchangeable catwalk assembly and said extendable interchangeable ladder assembly;
a telescopic adjustable safety-handrail assembly telescopically and adjustably connected to and vertically extending from said extendable interchangeable catwalk assembly; and
an operation remote control;
wherein
the roadworthy over-and-under-bridge-access boom trailer is
for being towed on a road to eliminate the need for an extra trailer to carry said turret assembly, said extendable interchangeable boom assembly, said extendable interchangeable ladder assembly, and said extendable interchangeable catwalk assembly,
for operating within the width of a sidewalk or lane, and
for lifting and shifting equipment and personnel through a narrow opening or
into a nook of a bridge, in a bridge, on a bridge, over bridge, or under a bridge;
said roadworthy wheeled chassis is for providing a roadworthy mobile platform;
said anti-slip deck is for providing friction to prevent slip;
said independently-adjustable trailer-leveling motorized legs each are for being independently and motorizedly adjustable to have different heights to level said trailer;
said leg bases each are for stabilizing one of said independently-adjustable trailer-leveling motorized legs;
said front vault is for storing equipment,
said stop-and-go lights each are for facilitating communications between personnel;
said rear vault is for storing equipment;
said pneumatic-tool compressor assembly is for conveniently operating pneumatic tools;
said turret assembly is for radially rotating said extendable interchangeable boom assembly, said extendable interchangeable ladder assembly, and said extendable interchangeable catwalk assembly;
said extendable interchangeable boom assembly, said extendable interchangeable ladder assembly, and said extendable interchangeable catwalk assembly are for lifting and shifting equipment and personnel over and under a bridge;
said quick-release boom-to-turret coupler is for quickly coupling and uncoupling said extendable interchangeable boom assembly to and from said turret assembly, respectively;
said quick-release ladder-to-boom coupler is for quickly coupling and uncoupling said extendable interchangeable ladder assembly to and from said extendable interchangeable boom assembly, respectively;
said quick-release catwalk-to-ladder coupler is for quickly coupling and uncoupling said extendable interchangeable catwalk assembly to and from said extendable interchangeable ladder assembly, respectively;
said safety-cable-attaching rungs each are for safety cables to be hooked thereon,
said telescopic adjustable safety-handrail assembly is for prevent personnel from falling off said extendable interchangeable catwalk assembly and for personnel to hold on as added safety;
said operation remote control is for operating said turret assembly, said extendable interchangeable boom assembly, said extendable interchangeable ladder assembly, and said extendable interchangeable catwalk assembly; and
said extendable interchangeable catwalk assembly is sized for lifting and shifting equipment and personnel through a narrow opening or into a nook of a bridge, in a bridge, on a bridge, over bridge, or under a bridge;
whereby
the roadworthy over-and-under-bridge-access boom trailer:
can be towed on a road
to eliminate the need for an extra trailer,
to eliminate the need for loading it on and unloading it from an extra trailer to move it from one bridge to another,
to eliminate the need for assembling and disassembling it to move it from one bridge to another,
to save labor, time, and money,
to eliminate injuries;
can operate within the width of a sidewalk or lane;
can lift and shift equipment and personnel through a narrow opening or into a nook of a bridge, in a bridge, on a bridge, over bridge, or under a bridge;
can work with:
a suspension-cable-type bridge,
a truss-type bridge,
a low-power-line bridge,
a high-power-line bridge,
a short-supporting-column bridge,
a tall-supporting-column bridge,
a single-lane bridge,
a multiple-lane bridge,
a regular bridge, and
a rail-road bridge;
can allow, while situated on a bridge, at least one additional extendable interchangeable catwalk assembly to quickly couple and uncouple to and from said extendable interchangeable catwalk assembly to extend and shrink the width or length of said extendable interchangeable catwalk assembly, respectively, to service the whole bridge width or length over or under a bridge;
can be leveled using said independently-adjustable trailer-leveling motorized legs to work on an even or uneven terrain;
can quickly interchange, while situated on a bridge, said extendable interchangeable boom assembly, said extendable interchangeable ladder assembly, and said extendable interchangeable catwalk assembly;
can work safely in the proximity of low power lines on a bridge,
can provide said telescopic adjustable safety-handrail assembly to prevent personnel from falling off said extendable interchangeable catwalk assembly;
can provide said safety-cable-attaching rungs to hook safety cables on as added safety;
can conveniently store equipment onboard using said front vault and said rear vault;
can conveniently operate pneumatic tools onboard using said pneumatic-tool compressor assembly; and
can be operated from said extendable interchangeable catwalk assembly or from a distance using said operation remote control.

2. The roadworthy over-and-under-bridge-access boom trailer of claim 1, wherein, said extendable interchangeable catwalk assembly is sized to lift and shift equipment and personnel through a small opening less than thirty inches wide between cables, posts, or rails of:
a suspension-cable-type bridge,
a truss-type bridge,
a low-power-line bridge,
a high-power-line bridge,
a short-supporting-column bridge,
a tall-supporting-column bridge,
a single-lane bridge,
a multiple-lane bridge,
a regular bridge, or
a rail-road bridge.

3. The roadworthy over-and-under-bridge-access boom trailer of claim 1, wherein, the roadworthy over-and-under-bridge-access boom trailer is sized to operate within the width of a sidewalk or lane.

4. The roadworthy over-and-under-bridge-access boom trailer of claim 1, further, comprising at least one catwalk-to-catwalk coupler and at least one additional extendable interchangeable catwalk assembly, said at least one catwalk-to-catwalk coupler for quickly coupling and uncoupling said extendable interchangeable catwalk assembly to and from said at least one additional extendable interchangeable catwalk assembly, said at least one additional extendable interchangeable catwalk assembly for extending and shrink the width or length of said extendable interchangeable catwalk assembly to lift and shift equipment and personnel over or under a bridge, respectively.

5. The roadworthy over-and-under-bridge-access boom trailer of claim 4, wherein, said extendable interchangeable catwalk assembly has two opposite sides; said extendable interchangeable catwalk assembly is coupled to said at least one additional extendable interchangeable catwalk assembly on said two opposite sides, respectively.

6. The roadworthy over-and-under-bridge-access boom trailer of claim 4, wherein, said extendable interchangeable catwalk assembly and said at least one additional extendable interchangeable catwalk assembly have a combined width or length generally equal to the width or length of a bridge, respectively.

7. The roadworthy over-and-under-bridge-access boom trailer of claim 1, further, comprising an anti-slip coating attached to said anti-slip deck for preventing slip.

8. The roadworthy over-and-under-bridge-access boom trailer of claim 1, wherein, said said quick-release boom-to-turret coupler has at least one hole, at least one nut, and at least one screw; said at least one screw is for being inserted through said at least one hole; said at least one nut is for being screwed on said at least one screw to secure said at least one screw.

9. The roadworthy over-and-under-bridge-access boom trailer of claim 1, wherein, said said quick-release ladder-to-boom coupler has at least one hole, at least one nut, and at least one screw; said at least one screw is for being inserted through said at least one hole; said at least one nut is for being screwed on said at least one screw to secure said at least one screw.

10. The roadworthy over-and-under-bridge-access boom trailer of claim 1, wherein, said said quick-release catwalk-to-ladder coupler has at least one hole, at least one nut, and at least one screw; said at least one screw is for being inserted through said at least one hole; said at least one nut is for being screwed on said at least one screw to secure said at least one screw.

11. The roadworthy over-and-under-bridge-access boom trailer of claim 1, further, comprising a plurality of safety footwalls, wherein said extendable interchangeable catwalk assembly having a floor, said safety footwalls welded to and along the perimeter of said floor for preventing personnel from sliding off or stepping off said floor.

12. The roadworthy over-and-under-bridge-access boom trailer of claim 1, wherein, said telescopic adjustable safety-handrail assembly has at least one hole and at least one pin; said at least one pin is for being inserted through at least one of said at least one hole to adjustably secure said telescopic adjustable safety-handrail assembly.

13. The roadworthy over-and-under-bridge-access boom trailer of claim 1, further, comprising a safety chain releasably attached to said extendable interchangeable catwalk assembly, wherein said extendable interchangeable catwalk assembly having an entry-exit opening, said safety chain for releasably closing said entry-exit opening.

14. A roadworthy over-and-under-bridge-access boom trailer, for being towed on a road to eliminate the need for an extra trailer, for operating within the width of a sidewalk, and for lifting and shifting equipment and personnel through a narrow opening or into a nook over or under a bridge, comprising:
a roadworthy wheeled chassis having an upper side, an underside, and a plurality of corners;
an anti-slip deck welded to said upper side of said roadworthy wheeled chassis;
a plurality of adjustable trailer-leveling motorized legs each attached to said underside of said roadworthy wheeled chassis at one of said corners;
at least one vault attached to said anti-slip deck;
a plurality of stop-and-go lights attached to said at least one vault;
a pneumatic-tool compressor assembly attached to said anti-slip deck;
a turret assembly rotatably attached to said anti-slip deck;
an extendable boom assembly releasably attached to said turret assembly;
a quick-release boom-to-turret coupling means attached to said extendable boom assembly and said turret assembly;
an extendable ladder assembly releasably attached to said extendable boom assembly;
a quick-release ladder-to-boom coupling means attached to said extendable ladder assembly and said extendable boom assembly;
a plurality of safety-cable-attaching rungs welded to said extendable ladder assembly;
an extendable catwalk assembly releasably attached to said extendable ladder assembly;
a quick-release catwalk-to-ladder coupling means attached to said extendable catwalk assembly and said extendable ladder assembly;
an adjustable safety-handrail assembly adjustably connected to and vertically extending from said extendable catwalk assembly; and
an operation remote control;
wherein
the roadworthy over-and-under-bridge-access boom trailer is
for being towed on a road to eliminate the need for an extra trailer to carry said turret assembly, said extendable boom assembly, said extendable ladder assembly, and said extendable catwalk assembly,
for operating within the width of a sidewalk or lane, and
for lifting and shifting equipment and personnel through a narrow opening or into a nook of a bridge, in a bridge, on a bridge, over bridge, or under a bridge;
said roadworthy wheeled chassis is for providing a roadworthy mobile platform;
said anti-slip deck is for providing friction to prevent slip;
said adjustable trailer-leveling motorized legs each are for being independently and motorizedly adjustable to have different heights to level said trailer;
said at least one vault is for storing equipment;
said stop-and-go lights each are for facilitating communications between personnel;
said pneumatic-tool compressor assembly is for conveniently operating pneumatic tools;
said turret assembly is for radially rotating said extendable boom assembly, said extendable ladder assembly, and said extendable catwalk assembly;
said extendable boom assembly, said extendable ladder assembly, and said extendable catwalk assembly are for lifting and shifting equipment and personnel over and under a bridge;
said quick-release boom-to-turret coupling means is for quickly coupling and uncoupling said extendable boom assembly to and from said turret assembly, respectively;
said quick-release ladder-to-boom coupling means is for quickly coupling and uncoupling said extendable ladder assembly to and from said extendable boom assembly, respectively;
said quick-release catwalk-to-ladder coupling means is for quickly coupling and uncoupling said extendable catwalk assembly to and from said extendable ladder assembly, respectively;
said safety-cable-attaching rungs each are for safety cables to be hooked thereon;
said adjustable safety-handrail assembly is for prevent personnel from falling off said extendable catwalk assembly;
said operation remote control is for operating said turret assembly, said extendable boom assembly, said extendable ladder assembly, and said extendable catwalk assembly; and
said extendable catwalk assembly is sized for lifting and shifting equipment and personnel through a narrow opening or into a nook of a bridge, in a bridge, on a bridge, over bridge, or under a bridge;
whereby
the roadworthy over-and-under-bridge-access boom trailer:
can be towed on a road
to eliminate the need for an extra trailer,
to eliminate the need for loading it on and unloading it from an extra trailer to move it from one bridge to another,
to eliminate the need for assembling and disassembling it to move it from one bridge to another,
to save labor, time, and money,
to eliminate injuries;
can operate within the width of a sidewalk or lane;
can lift and shift equipment and personnel through a narrow opening or into a nook of a bridge, in a bridge, on a bridge, over bridge, or under a bridge;
can work with:
a suspension-cable-type bridge,
a truss-type bridge,
a low-power-line bridge,
a high-power-line bridge,
a short-supporting-column bridge,
a tall-supporting-column bridge,
a single-lane bridge,
a multiple-lane bridge,
a regular bridge, and
a rail-road bridge;
can allow, while situated on a bridge, at least one additional extendable catwalk assembly to quickly couple and uncouple to and from said extendable catwalk assembly to extend and shrink the width or length of said extendable catwalk assembly, respectively, to service the whole bridge width or length over or under a bridge;
can be leveled using said adjustable trailer-leveling motorized legs to work on an even or uneven terrain;
can quickly interchange, while situated on a bridge, said extendable boom assembly, said extendable ladder assembly, and said extendable catwalk assembly;
can work safely in the proximity of low power lines on a bridge,
can provide said telescopic adjustable safety-handrail assembly to prevent personnel from falling off said extendable catwalk assembly;
can provide said safety-cable-attaching rungs to hook safety cables on as added safety;
can conveniently store equipment onboard using said at least one vault;
can conveniently operate pneumatic tools onboard using said pneumatic-tool compressor assembly; and
can be operated from said extendable catwalk assembly or from a distance using said operation remote control.

15. The roadworthy over-and-under-bridge-access boom trailer of claim 14, wherein, said extendable interchangeable catwalk assembly is sized to lift and shift equipment and personnel through a small opening less than thirty inches wide between cables, posts, or rails of:
a suspension-cable-type bridge,
a truss-type bridge,
a low-power-line bridge,
a high-power-line bridge,
a short-supporting-column bridge,
a tall-supporting-column bridge,
a single-lane bridge,
a multiple-lane bridge,
a regular bridge, or
a rail-road bridge.

16. The roadworthy over-and-under-bridge-access boom trailer of claim 14, wherein, the roadworthy over-and-under-bridge-access boom trailer is sized to operate within the width of a sidewalk or lane.

17. The roadworthy over-and-under-bridge-access boom trailer of claim 14, further, comprising at least one catwalk-to-catwalk coupling means and at least one additional extendable interchangeable catwalk assembly, said at least one catwalk-to-catwalk coupling means for quickly coupling and uncoupling said extendable interchangeable catwalk assembly to and from said at least one additional extendable interchangeable catwalk assembly, said at least one additional extendable interchangeable catwalk assembly for extending and shrink the width or length of said extendable interchangeable catwalk assembly to lift and shift equipment and personnel over or under a bridge, respectively.

18. The roadworthy over-and-under-bridge-access boom trailer of claim 17, wherein, said extendable interchangeable catwalk assembly has two opposite sides; said extendable interchangeable catwalk assembly is coupled to said at least one additional extendable interchangeable catwalk assembly on said two opposite sides, respectively.

19. The roadworthy over-and-under-bridge-access boom trailer of claim 17, wherein, said extendable interchangeable catwalk assembly and said at least one additional extendable interchangeable catwalk assembly have a combined width or length generally equal to the width or length of a bridge, respectively.

20. A roadworthy over-and-under-bridge-access boom trailer, for lifting and shifting equipment and personnel through a narrow opening or into a nook over or under a bridge, comprising:
a roadworthy wheeled chassis having an upper side, an underside, and a plurality of corners;
a deck welded to said upper side of said roadworthy wheeled chassis;
a plurality of trailer-leveling legs each attached to said underside of said roadworthy wheeled chassis at one of said corners;
at least one vault attached to said deck;
a plurality of lights attached to said at least one vault;
a pneumatic-tool compressor assembly attached to said deck;
a turret assembly rotatably attached to said deck;
a boom assembly releasably attached to said turret assembly;
a boom-to-turret coupling means attached to said boom assembly and said turret assembly;
a ladder assembly releasably attached to said boom assembly;
a ladder-to-boom coupling means attached to said ladder assembly and said boom assembly;
a plurality of rungs welded to said ladder assembly;
a catwalk assembly releasably attached to said ladder assembly;
a catwalk-to-ladder coupling means attached to said catwalk assembly and said ladder assembly;
a safety-handrail assembly adjustably connected to and vertically extending from said catwalk assembly; and
a remote control;
wherein
the roadworthy over-and-under-bridge-access boom trailer is
for being towed on a road to eliminate the need for an extra trailer to carry said turret assembly, said boom assembly, said ladder assembly, and said catwalk assembly,
for operating within the width of a sidewalk or lane, and
for lifting and shifting equipment and personnel through a narrow opening or into a nook of a bridge, in a bridge, on a bridge, over bridge, or under a bridge;
said roadworthy wheeled chassis is for providing a roadworthy mobile platform;
said deck is for providing friction to prevent slip;
said trailer-leveling legs are for being adjustable to have different heights to level said trailer;
said at least one vault is for storing equipment;
said lights are for facilitating communications between personnel;
said pneumatic-tool compressor assembly is for conveniently operating pneumatic tools;
said turret assembly is for radially rotating said boom assembly, said ladder assembly, and said catwalk assembly;
said boom assembly, said ladder assembly, and said catwalk assembly are for lifting and shifting equipment and personnel over and under a bridge;
said boom-to-turret coupling means is for quickly coupling and uncoupling said boom assembly to and from said turret assembly, respectively;
said ladder-to-boom coupling means is for quickly coupling and uncoupling said ladder assembly to and from said boom assembly, respectively;
said catwalk-to-ladder coupling means is for quickly coupling and uncoupling said catwalk assembly to and from said ladder assembly, respectively;
said rungs are for safety cables to be hooked thereon;
said safety-handrail assembly is for prevent personnel from falling off said catwalk assembly;
said remote control is for operating said turret assembly, said boom assembly, said ladder assembly, and said catwalk assembly; and
said catwalk assembly is sized for lifting and shifting equipment and personnel through a narrow opening or into a nook of a bridge, in a bridge, on a bridge, over bridge, or under a bridge;
whereby
the roadworthy over-and-under-bridge-access boom trailer:
can be towed on a road
to eliminate the need for an extra trailer,
to eliminate the need for loading it on and unloading it from an extra trailer to move it from one bridge to another,
to eliminate the need for assembling and disassembling it to move it from one bridge to another,
to save labor, time, and money,
to eliminate injuries;
can operate within the width of a sidewalk or lane;
can lift and shift equipment and personnel through a narrow opening or into a nook of a bridge, in a bridge, on a bridge, over bridge, or under a bridge;
can work with:
a suspension-cable-type bridge,
a truss-type bridge,
a low-power-line bridge,
a high-power-line bridge,
a short-supporting-column bridge,
a tall-supporting-column bridge,
a single-lane bridge,
a multiple-lane bridge,
a regular bridge, and
a rail-road bridge;
can allow, while situated on a bridge, at least one additional catwalk assembly to quickly couple and uncouple to and from said catwalk assembly to extend and shrink the width or length of said catwalk assembly, respectively, to service the whole bridge width or length over or under a bridge;
can be leveled using said trailer-leveling legs to work on an even or uneven terrain;
can quickly interchange, while situated on a bridge, said boom assembly, said ladder assembly, and said catwalk assembly;
can work safely in the proximity of low power lines on a bridge,
can provide said safety-handrail assembly to prevent personnel from falling off said catwalk assembly;
can provide said rungs to hook safety cables on as added safety;
can conveniently store equipment onboard using said at least one vault;
can conveniently operate pneumatic tools onboard using said pneumatic-tool compressor assembly; and
can be operated from said catwalk assembly or from a distance using said remote control.
